(19) United States
(12) Patent Application Publication
(10) Pub. No.: US 2004/0019542 A1
(43) Pub. Date: Jan. 29, 2004

(54) Timesheet reporting and extraction system and method

(75) Inventors: Fred S. Fuchs, Basking Ridge, NJ (US); Joel D. Vincett, Hasbrouck Heights, NJ (US); Jennifer R. Russell, Stanhope, NJ (US); Robert L. Di Taranti, Saddle Brook, NJ (US)

Correspondence Address: PILLSBURY WINTHROP, LLP, P.O. BOX 10500, MCLEAN, VA, 22102, US

(73) Assignee: UBS PaineWebber Inc., Weehawken, NJ

(21) Appl. No.: 10/205,204

(22) Filed: Jul. 26, 2002

(51) Int. Cl. G06F 17/60

(52) U.S. Cl. 705/32

(57) ABSTRACT

A timesheet reporting and extraction system and method includes accepting time entry data from a first user using a computing device. The entered data is compared to a predefined work schedule and discrepancies are noted for overtime or other compensation adjustments. Timesheet information and adjustment information are organized into a file and uploaded to a server for database storage and report processing, and may be converted and output to a central processing system such as a payroll system. A second user approves timesheet entries using a second computing device.

This disclosure contains information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### BACKGROUND OF THE INVENTION

1. Field of the Invention

The present invention relates to systems and methods for collecting and reporting employee time spent on work tasks and, in particular, to automated systems and methods for time entry and approval.

2. General Background and Description of Related Art

Employees in a corporate setting are typically required to account for their time spent working on company business. Oftentimes, an employee may be compensated above her standard pay rate for time worked in addition to her scheduled working time for a given period of time. This situation may be referred to as overtime pay. Other times, an employee may be compensated by his employer at less than his standard pay rate, or he may receive less pay in a subsequent pay period, if he works less time than his scheduled working time. Time worked may be reviewed for these purposes by the employer on a periodic basis, such as a daily basis, or for a standard period such as a workweek.

Overtime pay may be due to an employee in a variety of circumstances. For example, if an employee works more hours in a given day or workweek than she is scheduled to work, then she may receive overtime pay for the additional time worked. Another example is the employee who works on a designated holiday; in this case, the employee may be entitled to be compensated at her regular pay rate for the full day in payment for the holiday, and in addition, for time actually worked at her standard rate, her overtime rate, or a special rate (e.g., “double time”).

Many times, whether overtime pay is due for hours worked in addition to a daily minimum or, alternatively, on a workweek basis, is determined by the overtime rules that apply to a particular employee. Overtime rules may be controlled by jurisdictional laws. For example, the overtime rules that apply to an employee working in a particular office, manufacturing facility, warehouse, etc. may be subject to the labor laws of the jurisdiction, e.g., country, state, province, county, city, etc., in which the place of employment is located. Overtime rules may vary, therefore, based upon the geographic location of the employee, which greatly complicates the compensation determination for each employee. The larger the corporation and diversity of working locations, time collecting, approval, and payroll processing become increasingly complex.

For example, the law of the state of California currently requires that hourly employees be compensated at a pay rate of 1½ times the standard pay rate for each hour worked in excess of eight hours per day and at 2 times the standard pay rate for each hour worked in excess of 12 hours per day. Many other states impose the 1½ times standard rate for overtime for each hour worked in excess of a 40 hour workweek, with no daily standard rate maximum. Other states have no laws imposing overtime rates at all. Still others base overtime compensation on a workweek definition other than 40 standard hours, or based upon the employee's standard base rate.

In addition to legal obligations, a corporation may choose to compensate employees according to different rates or hourly minimums depending upon the location of the work place, the type of work being performed, the position held by the employee, or based upon competitive factors.

A national corporate enterprise may undertake significant effort in determining the proper and legally required overtime compensation due to each of its employees in each separate jurisdiction. This determination presents a substantial burden on the administration of the corporation, its personnel and its support systems.

### SUMMARY OF THE INVENTION

At least one embodiment of the present invention relates to a system and method for collecting and reporting employee time spent on work tasks, time entry, and approval of time entered. The invention may utilize various levels of automation, e.g., none, semi-automation and fully automation, for performed operations and may apply a number of business rules to collected timesheet information to determine appropriate compensation to be paid to each timesheet submitting employee. In particular, the present invention may include performing an overtime calculation based on an employee's actual time worked, a pre-defined workweek, and a set of business rules including overtime rules.

### BRIEF DESCRIPTION OF THE DRAWINGS

Utility of the embodiments of the invention will be readily appreciated and understood from consideration of the following detailed description of the embodiments of this invention, when taken with the accompanying drawings, in which same numbered elements are identical and:

FIG. 1 illustrates an embodiment of a timesheet reporting and extraction system (TRAX) according to the present invention;

FIG. 2 is a block diagram of a computer system implementation for a computing device and server according to at least one embodiment of the present invention;

FIG. 3 is an exemplary database record description of a timesheet database utilized in accordance with at least one embodiment of the present invention;

FIG. 4 illustrates application code segments included in at least one embodiment of the present invention;

FIG. 5 illustrates the flow of time entry and approval information throughout a system according to at least one embodiment of the present invention;

FIG. 6 is an exemplary employee setup page according to at least one embodiment of the present invention;

FIG. 7 is an exemplary schedule setup page according to at least one embodiment of the present invention;

FIG. 8 is an exemplary employee schedule assignment page according to at least one embodiment of the present invention;

FIG. 9 is an exemplary employee planned absence page according to at least one embodiment of the present invention;

FIG. 10 is an exemplary planned absence approvals page according to at least one embodiment of the present invention;

FIG. 11 is an exemplary timesheet page according to at least one embodiment of the present invention;

FIG. 12 is an exemplary timesheet approvals summary page according to at least one embodiment of the present invention;

FIG. 13 is an exemplary historical adjustment detail page according to at least one embodiment of the present invention;

FIG. 14 is a flow chart of a timesheet reporting and extraction method in accordance with at least one embodiment of the present invention;

FIG. 15 illustrates an example of a timesheet approval—revised Financial Advisor (FA) charges page according to at least one embodiment of the present invention;

FIG. 16 illustrates an example of a timesheet approval—premium pay page according to at least one embodiment of the present invention;

FIG. 17 illustrates an example of a historical adjustment selection page according to at least one embodiment of the present invention;

FIG. 18 is an example of a report provided by at least one embodiment showing employees with missing timesheets;

FIG. 19 is an example of a report provided by at least one embodiment showing employees without schedule assignments; and

FIG. 20 is an example of a report provided by at least one embodiment showing cost centers with unapproved timesheets.

### DETAILED DESCRIPTION OF EMBODIMENTS OF THE INVENTION

Embodiments of the present invention may include or implement a timesheet reporting and extraction method, including a system automated to some degree and a method for collecting and reporting employee time spent on work tasks, time entry, and approval of time entered. Embodiments of the present invention allow employees to enter in/out time for each workday and allow supervisors to monitor and approve/disapprove these entry times. Furthermore, each employee's regular, additional, and overtime hours may be determined using common organization approved calculation routines. In addition, embodiments of the present invention may generate transactions based upon calculated hours for upload to a central processing system for execution.

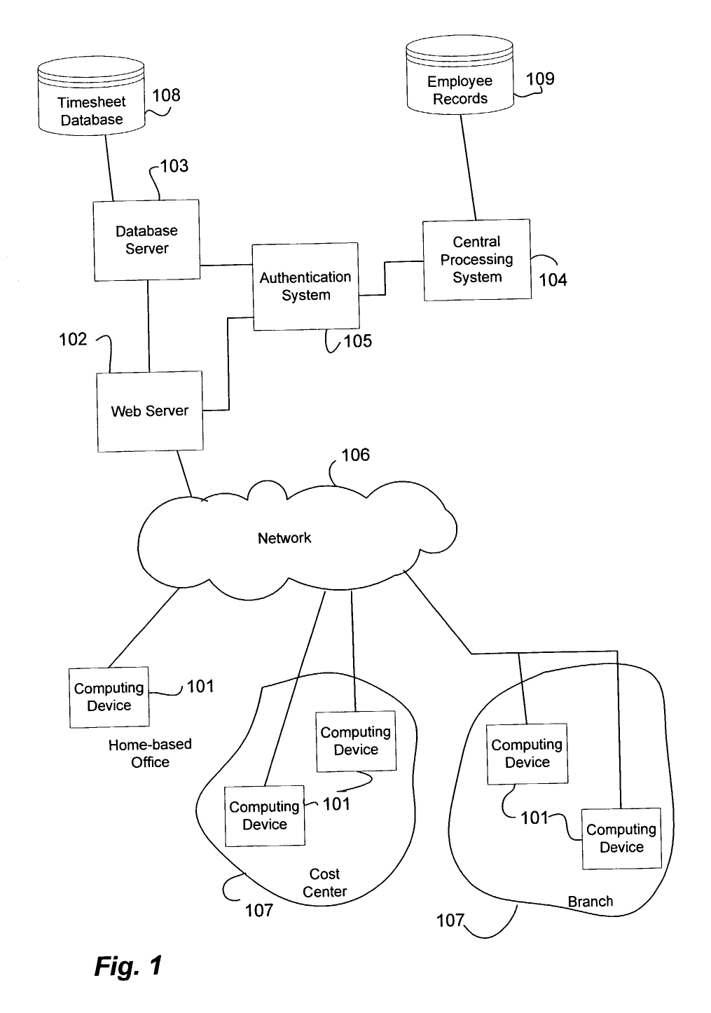

FIG. 1 illustrates a timesheet reporting and extraction system (TRAX) 100 according to at least one embodiment of the present invention. Referring to FIG. 1, the TRAX 100 system may include one or more computing devices 101, which may communicate with a web server 102 using a network 106. The web server 102 may be coupled to a database server 103, which may also be coupled to a timesheet database 108 for data storage and retrieval. In accordance with at least one embodiment, the web server 102 may be implemented using a single hardware and software computing platform, such as a Sun® workstation available from Sun Microsystems® of Palo Alto, Calif. In other embodiments, the web server 102 may be implemented across multiple such computing platforms. In addition, the database server 103 and the web server 102 may both be implemented using the same computing platform. In at least one embodiment, the web server 102 may be implemented using at least two computing platforms, a primary web server and a dual redundant web server. If both platforms are operating normally, communications traffic associated with the TRAX 100 system may be routed to each platform for load balancing. In the event of failure of one platform, TRAX 100 system traffic may be automatically routed to the other platform.

The web server 102 and database server 103 may be coupled to a central processing system 104. In accordance with at least one embodiment, the web server 102 and database server 103 may communicate with the central processing system 104 via an authentication system 105. An authentication system 105 may provide security or firewall protection against unauthorized access to the central processing system 105. In an embodiment, the authentication system 105 is a modifications/additions/changes processing system front end to the central processing system 104. In accordance with at least embodiment, the central processing system 104 may be a payroll system. The central processing system 104 may be coupled to an employee records database 109 for data storage and retrieval.

As shown in FIG. 1, more than one computing device 101 may be present within a particular facility 107. A facility 107 may be a location or presence associated with an organization, such as a corporation. For example, the facility 107 may be a cost center associated with an organization, or a branch office or location, manufacturing facility, headquarters, warehouse, or any other such organizational location. The facility 107 may be located within a particular governmental jurisdiction such as, but not limited to, a country, state, province, municipality etc., for determination of overtime rules that may apply to employees working at the facilities 107 within a given jurisdiction. A computing device 101 may also be located at the residence of a home office user, which may not be collocated with a facility 107.

The computing device 101 may be a personal computing with a browser, such as a World Wide Web browser application. Alternatively, the computing device 101 may be a wireless terminal such as a personal digital assistant, a cellular or portable telephone terminal, or an Internet appliance.

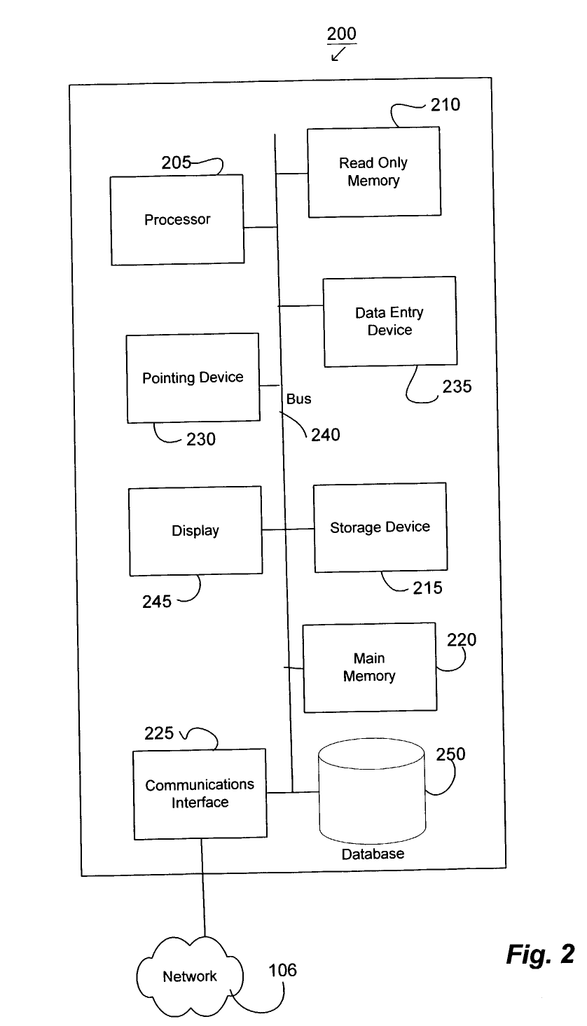

FIG. 2 is a block diagram of a computer system 200 which may be used to implement a computing device 101, web server 102, and database server 103 in accordance with at least one embodiment-of the invention. The computer system 200 may include a bus 240 or other communication mechanism for communicating information, and a processor 205 coupled with the bus 240 for processing information. The computer system 200 also may include a main memory 220, such as a random access memory (RAM) or other dynamic storage device, coupled to the bus 240 for storing information and instructions to be executed by the processor 205. The main memory 220 also may be used for storing temporary variable or other intermediate information during execution of instructions to be executed by the processor 205. The computer system 200 further may include a read only memory (ROM) 210 or other static storage device coupled to the bus 240 for storing static information and instructions for the processor 205. A storage device 215, such as a magnetic disk or optical disk, may be provided and coupled to the bus 240 for storing information and instructions. In at least one embodiment, the web server 102 may be implemented using a Sun4U® model 420R server and the database server 103 may be implemented using an RS6000® model 270 server, both available from Sun Microsystems®.

In accordance with at least one embodiment, the database 250 may be coupled to the bus 240 for storing static information and software instructions. Information stored in or maintained using the database 250 may be provided in conformance with a database management system format such as, but not limited to, the Structured Query Language (SQL) format.

In accordance with at least one embodiment, the database 250 may be a Transact® SQL database provided by the Sybase® Corporation. Alternatively, the database 250 may be a SQL Server 7.0 database supporting the ActiveX Data Object (ADO) and Open Database Connectivity (ODBC) protocols provided by IBM® Corporation or Oracle® Corporation. The database 250 may include information including, but not limited to, database query and access instructions in the form of one or more scripts which, when executed by a processor such as the processor 205, serve to store and retrieve data maintained using the database 250 according to the instructions contained in the script, and in particular regarding the data fields to be accessed, as well as their arrangement, provided in the response to the processor 205.

The computer system 200 may be coupled via the bus 240 to a display 245 for outputting information to a computer user. In accordance with at least one embodiment, the display 245 may be a cathode ray tube (CRT) computer display monitor capable of displaying information using multiple colors. Alternatively, the display 245 may be a liquid crystal display or a monochrome monitor.

A data entry device 235, including alphanumeric and other keys, may be coupled to the bus 240 for communicating information and command selections to the processor 205. Another type of user input device which may be coupled to the bus 240 is a pointing device 230, which may be a computer mouse, trackball, cursor direction keypad, tactile directional fingerpad, or other such device for allowing a user to control cursor location and movement on the display 245, and for communicating direction information and command selections to the processor 205. This pointing device 230 may have, for example, two degrees of freedom in two axes, a first axis (e.g., x) and a second axis (e.g., y), that allow the pointing device to specify positions in a plane.

As explained above, the present invention is related to the use of the computer system 200 for time entry and management. According to at least one embodiment of the present invention, time entry management and timesheet reporting and extraction in the manner described earlier herein may be provided by the computer system 200,in response to the processor 205 executing one or more sequences of instructions contained in the main memory 220. Such instructions may be read into the main memory 220 from another computer-readable medium, such as the storage device 215 or database 250. Execution of the sequences of instructions contained in the main memory 220 may cause the processor 205 to perform the process steps described herein. One or more processors in a multi-processing arrangement may also be employed to execute the sequences of instructions contained in the main memory 220. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 205 for execution. Such a medium may take many forms, including, but not limited to, non-volatile media, volatile media, and transmission media. Non-volatile media include, for example, optical or magnetic disks, such as the storage device 215. Volatile media include dynamic memory, such as the main memory 220. Transmission media can also take the form of acoustic or light waves, such as those generated during Radio Frequency (RF) and InfraRed (IR) communications. Common forms of computer-readable media include, for example, floppy disk, a flexible disk, hard disk, magnetic tape, any other magnetic medium, a Compact Disc Read Only Memory (CD ROM), Digital Video Disc (DVD) or any other optical medium, punch cards, paper tape, any other physical medium with patterns of holes, a Random Access Memory (RAM), a Programmable Read Only Memory (PROM), an Erasable Programmable Read Only Memory (EPROM), a Flash Erasable Programmable Read Only Memory (EPROM), any other memory chip or cartridge, a carrier wave as described hereinafter, or any other medium from which a computer can read.

Various forms of computer-readable media may be involved in carrying one or more sequences of one or more instructions to the processor 205 for execution. For example, the instructions may initially be borne on a magnetic disk of a remote computer. The remote computer may load the instruction into its dynamic memory and send the instructions over a telephone line using a modem. A modem local to the computer system 200 may receive the data on the telephone line and use an infrared transmitter to convert the data to an infrared signal and place the data on the bus 240. The bus 240 may carry the data to the main memory 220, from which the processor 205 retrieves and executes the instructions. The instructions received by the main memory 220 may optionally be stored on the storage device 215 either before or after execution by the processor 205.

The computer system 200 may also include a communication interface 225 coupled to the bus 240. The communication interface 225 may provide a two-way data communication coupling to a network 260. For example, the communication interface 225 may be a modem or an Integrated Services Digital Network (ISDN) card to provide a data communication connection to a corresponding type of telephone line. As another example, the communication interface 225 may be a Local Area Network (LAN) card to provide a data communication connection to a compatible LAN. Wireless links may also be implemented. In any such implementation, the communication interface 225 sends and receives electrical, electromagnetic, or optical signals that carry digital data streams representing various types of information.

The communication interface 225 may provide data communication through one or more networks to other data devices. For example, the communication interface 225 may provide a connection through a local network to a host computer or to data equipment operated by an Internet Service Provider (ISP). The ISP may in turn provide data communication services through the worldwide packet data communication network, now commonly referred to as the “Internet.” These networks use electrical, electromagnetic, or optical signals that carry digital data streams. These signals are exemplary forms of carrier waves transporting the information.

In accordance with at least one embodiment, the communications interface 225 may include at least one Ethernet interface or a Local Area Network (LAN) communication card, a dial-up modem interface using the Public Switched Telecommunication Network (PSTN), an intranet, or any combination thereof.

The computer system 200 may send messages and receive data, including program codes, through the network(s) and the communication interface 225. When implemented in connection with the Internet, a server included in the computer system 200 might transmit a requested code for an application program through the Internet, ISP, and the communication interface 225. In accordance with at least one embodiment, one such downloaded application may provide for time entry management as described herein. The received code may be executed by the processor 205 as it is received, and/or stored in the storage device 215, or other non-volatile storage for later execution. In this manner, the computer system 200 may obtain an application code in the form of a carrier wave.

The web server 102 may receive commands and data from the computing devices 101 and output program code and data to the computing devices 101 using the network 106. In accordance with at least one embodiment, the web server 102 may generate and transmit the requested-information to the requesting user via Hypertext Transfer Markup Language (HTML) formatted or Extensible Markup Language (XML) formatted pages, which may be provided as World Wide Web pages, using the network 106. The network 106 may be, for example, a network of interconnected networks such as the Internet, a LAN, a Wide Area Network (WAN), an intranet including any of these, and/or the PSTN.

The communications interface 225 may further include a web browser or thin client 220. The web browser displays data and is capable of communicating with other computers via a network such as, for example, the Internet or an intranet. The web browser may provide a user with a way to navigate, via, for example, hyperlinks which are selected by the pointing device 230 such as a computer mouse, or as typed in by the user. The web browser may use a protocol such as, for example, HyperText Transfer Protocol (HTTP) or File Transfer Protocol (FTP), to transmit data of various content such as, for example, HTML formatted documents, plain text documents, graphic images, and XML documents for presentation to the user via the display 245.

Web pages formatted in accordance with HTML or XML may also be provided in accordance with the Extensible Style Language (XSL) specification available from the World Wide Web Consortium. XSL is useful for separating style from content as well as for providing a common interface for sharing of web pages across applications. The web browser may also run or execute programs, such as Java applets including sequences of instructions provided in accordance with the Javag programming language, or JavaScript®. The web browser may be, for example, Internet Explorer® by Microsoft® Corporation, Netscape Navigator® by Netscape®, or any other web browser. A thin client utilizes a two or more tiered client server model. In this model, the client may run a minimal set of services that provide functionality to interface with at least one server. A web browser may be a thin client. The web server 102 may run the Windows® NT network operating system available from Microsoft® Corporation of Redmond, Wash.

In at least one embodiment, instructions executed by the processor 205 from the main memory 220 may include application software instructions that cause the processor 205 to perform the operations described herein. In at least this embodiment, these application instructions may be implemented in the form of source code statements provided in accordance with the Visual C++® and Visual Basic® higher order programming languages, development kits for which are available from Microsoft® Corporation of Redmond; Wash. Other embodiments and implementations are possible. Application instructions may also include database scripts for accessing, storing, or selectively retrieving information contained in the database 250. The database scripts may be contained in the storage device 215 or may be stored using the database 250. The database scripts may be implemented in the form of programming statements provided in accordance with, for example, SQL version 7.0 database management system query language, as well as Transact® SQL in accordance with the ColdFusion® database management system. Other database implementations are possible, including those available from Oracle® or IBM DB2®.

In at least one embodiment, application software instructions include a user interface portion, which may be a Graphical User Interface (GUI) portion, for generating interactive pages or display screens (e.g., GUIs) by which a user may provide data to and receive information from the computer system 200 and database 250 using a human-machine interface such as, but not limited to, the display 245. Interactive pages may include one or more user dialog boxes for accepting user entered information. The human-machine interface may also include a hard-copy generating device such as a printer. A user may interact with the computer system 200 via the GUI provided by the GUI portion by using the pointing device 230 and data entry device 235. The GUI portion may place the output of computer system 200 in a format for presentation to a user via the display 245.

In particular, a user may select a particular data entry field of an interactive display page presented using the display 245 by using the pointing device 230 or data entry device 235 to select that field. Upon selecting a field, a user may then enter information into the data entry field using the data entry device 235. After the user has entered data into the data entry field, the user may cause the GUI portion to input the user-entered information to the computer system 200 using the pointing device 230 to select a corresponding display icon or command button.

The computing devices 101 may be collocated with the web server 102 or located remotely from the web server 102. The computing devices 101 may be present at a branch office, manufacturing facility, or other company presence or location, or may be located in an employee's private residence in the case of a home office or teleworking employee.

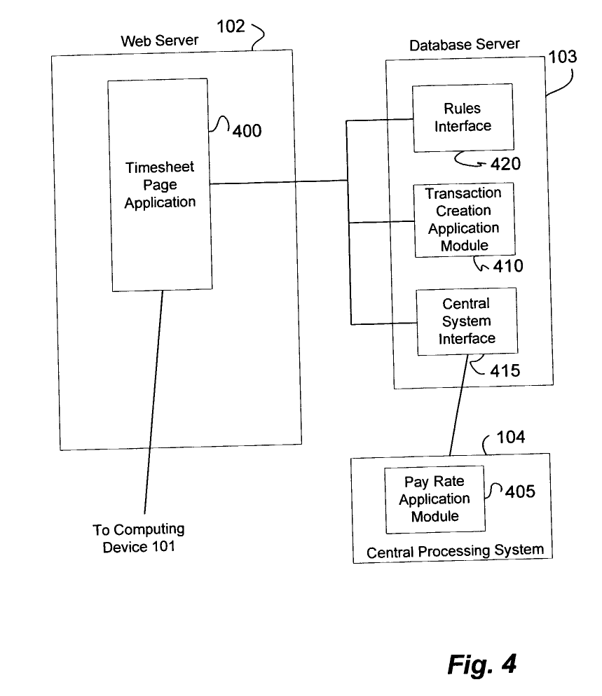

The computing device 101 may include programmed instructions for execution which cause the computing device 101 to perform method operations according to the embodiments as described herein. In accordance with at least one embodiment, the web server 102 may further include application program code segments operable to configure the computing device 101, web server 102, or database server 103 to perform operations as described herein. In particular, FIG. 4 illustrates application code segments included in TRAX 100 in accordance with at least one embodiment of the invention. Referring to FIG. 4, the TRAX 100 system may include a timesheet page application 400, a pay rate application module 405, a transaction creation application module 410, a central system interface 415, and a rules interface application module 420. These applications may be stored in the main memory 220 or storage device 215 of the computer system 200. Portions of code and data associated with these application modules may also be maintained using the timesheet database 108. In at least one embodiment, the pay rate application module 405 may reside on the central processing system 104, while the transaction creation application module 410 and the central system interface 415 may reside on the database server 103. The rules interface application module 420 may include information tables maintained using the database server 103. The rules interface application module 420 may communicate and interact with the timesheet page application 400 maintained using the web server 102, in causing the storing and retrieving of information to and from the timesheet database 108.

The timesheet page application 400 may be downloaded by the web server 102 to the computing device 101 via the network 106 in response to a user at computing device 101 requesting to access TRAX 100 for time entry (for example). In particular, in response to a user request, the computing device 101 may transmit a message requesting an initial interactive page for accessing the TRAX 100 system to be provided to the computing device 101. The computing device 101 may receive the user request, via data entry device, upon user selection of an associated hyperlink or upon a user entering a Uniform Resource Locator (URL) address associated with the web server 102 hosting the TRAX 100 system. The computing device 101 may transmit the message requesting access to the TRAX 100 system to the web server 102 as an HTML or XML formatted message in accordance with the HTTP protocol. In response, the web server 102 may transmit the timesheet page application 400 to the computing device 101 in accordance with, for example, the File Transfer Protocol (FTP), for execution by the computing device 101. Upon receiving the timesheet page application 400 from the web server 102, the computing device 101 may execute the timesheet page application 400 to provide the time entry and management functionality described herein, including accepting time information entered by an employee or user of the TRAX 100 system. In addition, the computing device 101 executing the timesheet page application 400 may further check for data entry constraints and exceptions conditions, such as the attempted entry of more vacation hours than the employee was scheduled to work on a particular day. The timesheet page application 400 may allow more than 24 hours of worked time to be accumulated in a single 24-hour period under certain circumstances, such as an employee who works over a holiday.

In at least one embodiment, the pay rate application module 405 may provide a report generation capability by which an administrative user may view information obtained from the timesheet database 108 according to a variety of views, arrangements, and aggregations (e.g., “data mining”).

The transaction creation application module 410 may include programmed instructions that cause the database server 103 to generate transaction information, based upon calculated timesheet information, for direct mainframe upload to the central processing system 104. Such transactions may be input to a batch process, and may effect payment of time based salary to non-exempt employees. In accordance with at least one embodiment of the invention, the central processing system 104 need not require TRAX 100 input to make automatic payment of guaranteed amounts to employees on the payroll; rather for employees with a guaranteed number of paid hours, the TRAX 100 system may output exceptions only to the central processing system 104. Such exceptions or time adjustment data may include: overtime for full-time employees, additional and overtime for locked part-time personnel, and RP (reduction-in-pay) for any employees working less than their scheduled number of hours. In the case of “hourly” part-time employees who do not have guaranteed (locked) hours, all payments (regular and overtime) may be generated as a result of TRAX 100 reported transactions.

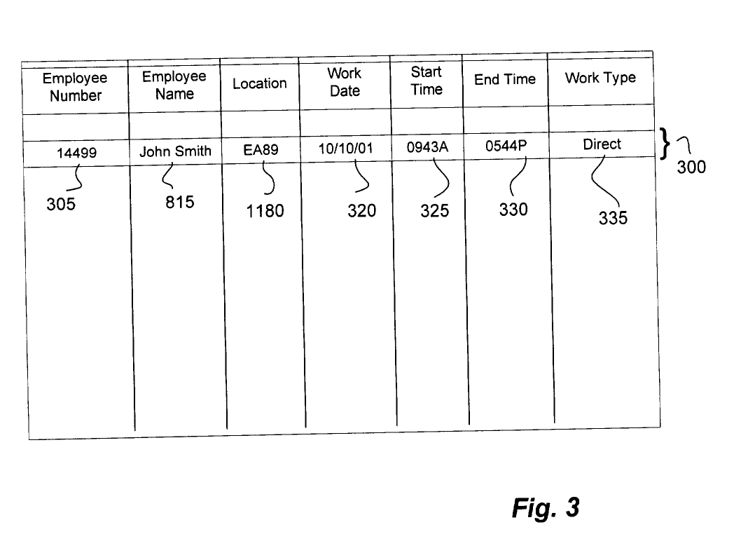

The central system interface 415 may include programmed instructions to permit the exchange of information between the database server 103 and the central processing system 104. In accordance with at least one embodiment, the central processing system 104 may be a payroll processing system. The database server 103 executing the central system interface 415 may provide to the central processing system 104 the user time file and timesheet information contained in the timesheet database 108 in a format suitable for use by the central processing system 104. In accordance with at least one embodiment, the web server 102 may provide user time file and timesheet information to the central processing system 104 in the form of a flat file sorted by cost center, and further sorted alphabetically by employee within each cost center. The database server 103 may include a dial-up modem interface for communicating with the central processing system 104 in accordance with instructions and control provided by the central system interface 415. An example of a timesheet database 108 record description is shown in FIG. 3. Referring to FIG. 3, a timesheet database 108 work entry record 300 may include an employee number 305, employee name 815, cost-center location 1180, work date 320, start time 325 and end time 330 entered by the user, and a work type 335. The employee number 305 may be, for example, a numeric or alphanumeric identifier assigned by an organization to an employee for tracking purposes. The work date 320 may be the date associated with the work entry record 300. The start time 325 and end time 330 may be, for example, the time entries provided by a user to the TRAX 100 system corresponding to the time in/out log 1145, for example. The work type 335 may, for example, specify employee compensation status information (e.g., vacation, personal day, work day). Other information contained in a record 300 may be as described elsewhere herein.

The rules interface application module 420 may include programmed instructions for causing the database server 103 to store and retrieve information to and from the timesheet database 108 in response to requests received from the web server 102. For example, the timesheet page application 400 of the web server 102 may obtain current schedule information for a particular employee from the timesheet database 108 via the database server 103 by outputting a request for the desired information to the rules interface application module 420 of the database server 103. The rules interface application module 420 may include instructions operable to cause the database server 103 to execute one or more database scripts for obtaining requested information or for storing information using the timesheet database 108. In accordance with at least one embodiment, the database server 103 includes a database management system such as, but not limited to, the Transact™ SQL database management system provided by Sybase Corporation of Emeryville, Calif., for storing and retrieving information to and from the timesheet database 108. The rules interface application module 420 may include instructions to configure the database server 103 for identifying and executing one or more SQL scripts operable to perform a particular information storage or retrieval function.

In accordance with at least one embodiment, compensation rules, overtime rules and other rules may be provided in the form of linked records included in the timesheet database 108. In at least one embodiment, these rules are maintained in the timesheet database 108 formatted in accordance with the ColdFusion™ language for ColdFusion™ version 5.0 available from Macromedia Corporation of Newton, Mass. In at least one other embodiment, compensation rules, overtime rules and other rules may be provided in the form of ColdFusion™ instructions directly in the rules interface application module 420 code. ColdFusion™ is a software application that runs on a server such as the web server 102 to process requests for web pages. Whenever a ColdFusion™ page is requested, the database server 103 executes the script or program the page contains.

In at least one embodiment, the computing device 101 may be configured to accept time entry data from a user via a data entry device, and then compare the entered time entry data to a predefined work schedule for the user. In particular, the computing device 101 may be configured to compare the employee's entered time to a set of geographically dependent overtime rules (for example, state specific “compensation” rules) and the employee's assigned work schedule to determine regular and overtime compensation due to the employee. The compensation rules used in the comparison may be selected from among a plurality of sets of compensation rules based upon, among other things, the user's location. In performing the comparison, the computing device 101 may use common calculation routines. Such common calculation routines may be predefined by an organization and maintained using the timesheet database 108. Common calculation routines may be released for use by an administrative user following organization approval (e.g., human resource management approval).

Based on the comparison of actual time worked to work schedule, the computing device 101 may generate time adjustment data, or a compensable time adjustment, that identifies discrepancies between the user-entered time entry data and the predefined work schedule for that user. The computing device 101 may compute compensable time based on the actual time worked as entered by the employee and based upon a number of business rules such as, but not limited to, work type, scheduled hours to be worked today for this employee, and the overtime rules for the cost center with which the employee is associated. Application of many and varying types of business rules may be used with various embodiments of the present invention. Furthermore, an administrative user such as a BTA may grant additional payments (Premium Pay) in response to, for example, subjective factors such as quality of work performed, or for other such reasons known to the administrator. This BTA modification may be in addition to the automated portions of the compensable time computation described herein.

The computing device 101 may then collect the user-provided time entry data, the predefined work schedule, and the compensable time adjustment into a user time file. The computing device 101 may transmit the user time file to the web server 102 using the network 106. The database server 103 may be configured to output the compensable time adjustment to the central processing system 104, which may be a payroll system. In accordance with at least one embodiment, the computing device 101 may transmit the user time file to the web server 102 upon the entering user completing his time entry. Upon receiving an indication from the user via a data entry device that the user has completed time entry, the computing device 101 may automatically transmit the user time file to the web server 102. In accordance with at least one other embodiment, the computing device 101 may prompt the user to select a “release” command, and transmit the user time file to the web server 102 in response to the user's selection of the release request. In at least one embodiment, a user may save his in/out punches to the timesheet database 108 (via the database server 103) throughout the week. This saving of intermediate in/out punch entries is to be contrasted with the “release” command. The release command may prevent any further update to the associated timesheet, and allow the BTA to make an approval decision based on the released timesheet information.

In accordance with at least one embodiment, the computing device 101 may be configured to accept only one or more start times and end times entered by the user. In at least this embodiment, the time entry data may include at least one pair of a start time and an end time. The computing device 101 may then calculate the total time worked based upon the start times and end times entered by the user. Alternatively, the computing device 101 may accept user entry of a sum total time for a work period in lieu of the start and end times for the period.

The TRAX 100 system may further provide the capability for a second user having supervisory administrative authority to approve the entered time for one or more employee users. In accordance with at least one embodiment, an employee user may enter her time worked as described herein using a first computing device 101. Subsequently, a supervisory administrative user may use a second computing device 101 to review the entered time and enter an approval indication operative to establish local administrative approval of the entered time entry data. The second computing device 101 may transmit a message indicating the approval to the web server 102.

In accordance with at least one embodiment, the web server 102 may generate and transmit one or more alert messages to supervisory administrative users informing of changes or conditions affecting employee work schedules (e.g., change in holiday observance date) or the TRAX 100 system. Such alert messages may be received and reported by the computing device 101 for BTAs and GTAs, or for group notification. In accordance with at least one embodiment, at least three classes of alerts may be supported: critical alerts, informational alerts, and warnings. Furthermore, certain alert messages may be automatically generated by the web server 102 in response to certain conditions, such as local failure or error conditions causing degraded system operation. An additional example of an automated alert is an alert sent to a BTA to solicit approval for an employee's planned absence request. Alternatively, the web server 102 may only generate alert messages in response to an administrative user entering the alert message and requesting its transmission, using the web server 102. An alert message may be provided by, for example, generating a corresponding record in a table which the computing device 101 is configured to read upon user access of a main menu of an initial interactive page in the current or next session established by the computing device 101 with the TRAX 100 system. Alert boxes are output to the user via human-machine interface as an overlay or defined field of additional information which may appear in the foreground of a currently output page. In accordance with at least one embodiment, a user may view and clear each alert message by selecting it using a data entry device or pointing device. In at least one embodiment, a pop-up menu listing the number of outstanding alerts grouped by alert class may be provided.

Furthermore, the web server 102 may be configured to permit user access to the information contained in the user time file, such as, but not limited to, timesheet information, according to multiple predefined access levels. Access levels provided by an embodiment of the TRAX 100 system may include a user level, a local administrator level, a general administrator level, and a national administrator level. At the user level, any user authenticated by the TRAX 100 system may access his entered timesheet information. Further, the user who entered time using the computing device 101 may edit, modify, or make additions to his entered timesheet information for a particular time reporting period until the timesheet information for that period has been released for approval by an administrative user. After the timesheet information has been approved, the user may only view the approved timesheet information. A user associated with user level access may not edit, modify, or make additions to timesheet information after its approval. Each user of the TRAX 100 system may be associated with an access level and this relationship is captured in the form of database records contained in the timesheet database 108 and records on a corporate security database, which may be employee records database 109.

At the local administrator level, a user associated with this level of access may have all of the access privileges of the user access level and, in addition, may have the ability to approve entered timesheet information by causing an approval indicator to be set that establishes timesheet information entered by a user as approved. In accordance with at least one embodiment, a local administrator, such as a BTA, or an organization level administrator such as a National Timesheet Administrator (NTA) or General Timesheet Administrator (GTA), may use a second computing device 101 to retrieve timesheet information entered by another employee user in order to view the entered timesheet information. After viewing the timesheet information entered by an employee user and confirming its content and format for correctness, the local administrator may then cause an approval indicator to be set, thereby establishing the corresponding timesheet information as approved for release for payroll processing or other internal purposes, by selecting an “approve” interactive display icon using a data entry device of the computing device 101. By entering this approval request, the computing device 101 may transmit an approval indicator to the web server 102 using the network 106. Upon receiving the approval indicator, the web server 102 may deny requested changes to the approved timesheet information sent by a user having user level access.

Alternatively, an administrative user, such as a BTA, may generate an approval report using the computing device 101. The approval report may list the approval status granted by the BTA for every employee submitting a timesheet 530 for a given reporting period. The approval report may be subsequently provided to organization payroll operations or accounting operations via its personnel such as a GTA. The approval report may be transmitted by the computing device 101 to the web server 102 upon administrative user request, or it may be provided directly to payroll operations personnel in hardcopy form.

Further to the different levels of access that may be provided by an embodiment of the TRAX 100 system, user level access may be afforded to an employee. An employee may be defined as any non-exempt personnel on the organization payroll. Employee users may utilize the TRAX 100 system to enter time worked for each day of the workweek (Sunday through Saturday), by interacting with the computing device 101 as described herein. In accordance with at least one embodiment, the TRAX 100 system also provides the capability for employee users to enter planned absences (e.g., vacation, floating holiday) using the computing device 101.

Further to the administrative users of the TRAX 100 system, BTAs may create work schedules, assign employees to work schedules, approve employee requested planned absences, monitor and approve employee entered time, and administer the TRX system for the branch/department. BTAs may be local timesheet administrators for a particular region such as, but not limited to, a cost center or a branch office. GTAs are regional timesheet administrators and may oversee BTAs. GTAs may assign BTA functions to designated employees, monitor BTA activity within their region, and function as a BTA when required. GTAs may have the ability to access and view time worked data for all cost centers except their own. NTAs may oversee GTAs and assign GTA functions to designated employees, monitor system activity, approve the TRAX 100 system transactions input for processing by the central processing system 104, and create and maintain reference tables such as, but not limited to, work rules (sick, jury duty, etc), official holidays (national and local), and overtime rules. NTAs may have the same access privileges and capabilities as GTAs, but may further have the ability to provide alert messages from the central processing location to the cost centers and-branch offices.

Other administrative users of the TRAX 100 system may include an Examining Timesheet Administrator (XTA) who may have the same access privileges and capabilities as a. GTA, but may not have the same responsibilities for updating rules and information as does the GTA.

In at least one embodiment, the compensation rules may further comprise a set of overtime rules. Overtime rules may vary depending upon the location of the employee or user entering the timesheet information. In accordance with at least one embodiment, an individual set of overtime rules may be provided for each state jurisdiction in which the organization has employees, since each jurisdiction may have different laws and regulations governing overtime labor rates and also the manner of determining which hours worked are counted as standard time versus overtime. For example, one state may require that every hour worked in excess of eight hours in a day be compensated as overtime, while another state may have no daily overtime limits but rather requires each hour worked in excess of forty hours in a week to be paid as overtime. In accordance with at least one embodiment, the set of overtime rules that apply in the jurisdiction in which the entering employee works may be used by the TRAX 100 system to determine the amount of overtime compensation due to that employee. The TRAX 100 system may select a particular set of overtime rules based upon the employee information associated with the employee entering the timesheet information. The computing device 101 may receive the employee information (that may include employee location) from the web server 102 via the network 106. As discussed earlier, the employee location may be any facility 107 associated with the organization, such as, but not limited to, a cost center associated with an organization, or a branch office or location, manufacturing facility, headquarters, warehouse, or any other such organizational location. A location of the facility 107 may also be associated with a particular governmental jurisdiction such as, but not limited to, a state, for determination of overtime rules that may apply to employees working at the facilities 107 at that location.

In at least one embodiment, the computing device 101 may be configured to represent the user time file as an electronic timesheet. The web server 102 may maintain multiple user time files using the timesheet database 108, via the database server 103. Upon user command, the web server 102 may generate a chronological timesheet history that includes timesheet information from at least one user time file. The web server 102 may receive a request from the computing device 101 for chronological timesheet history for one or more employees or users via the network 106. Upon receipt of the request, the web server 102 may verify the access level of the requesting user and confirm that the requesting user is authorized to access the requested information. For example, the web server 102 may honor such requests only from users having administrative access authority, as well as from the user who entered the time entry data (having user level access). Other requests may be denied. If the web server 102 verifies the request as being authorized, then the web server 102 may transmit a request to the database server 103 requesting the desired information. Upon receiving the request from the web server 102, the database server 103 may formulate and transmit a database request to the timesheet database 108 to cause the timesheet database 108 to return the requested information. Upon receiving the requested information from the timesheet database 108, the database server 103 may provide the obtained database information to the web server 102. Upon receiving the requested information from the database server 103, the web server 102 may generate an interactive page containing the requested data, such as HTML or XML formatted page, and transmit the page to the computing device 101 from which the request was received using the network 106. Chronological timesheet information may be requested for one or more particular employees, by location or cost center, or for a particular range of time.

In accordance with at least one embodiment, a user possessing an administrative access level may request chronological timesheet information to be adjusted, or restated, in response to changes made in the underlying time punches, or the type of hours (e.g., sick time or work time), for example, and to observe the resulting effects on employee compensation. The adjustment capability allows organization management to observe the real or potential impact on compensation cost structures associated with the change(s). In at least one embodiment, the underlying compensation rules may not change for the historical adjustment process. Further, timesheet adjustments may be made regardless of whether or not the particular timesheet or timesheets has or have been approved (e.g., whether or not the approval indicator is set) by an administrator such as a branch timesheet administrator. In addition, the adjustment capability may allow an administrative user to change the underlying work schedule. Further still, the historical adjustment capability may be used to enter timesheets after occurrence of the required date for timesheet submittal.

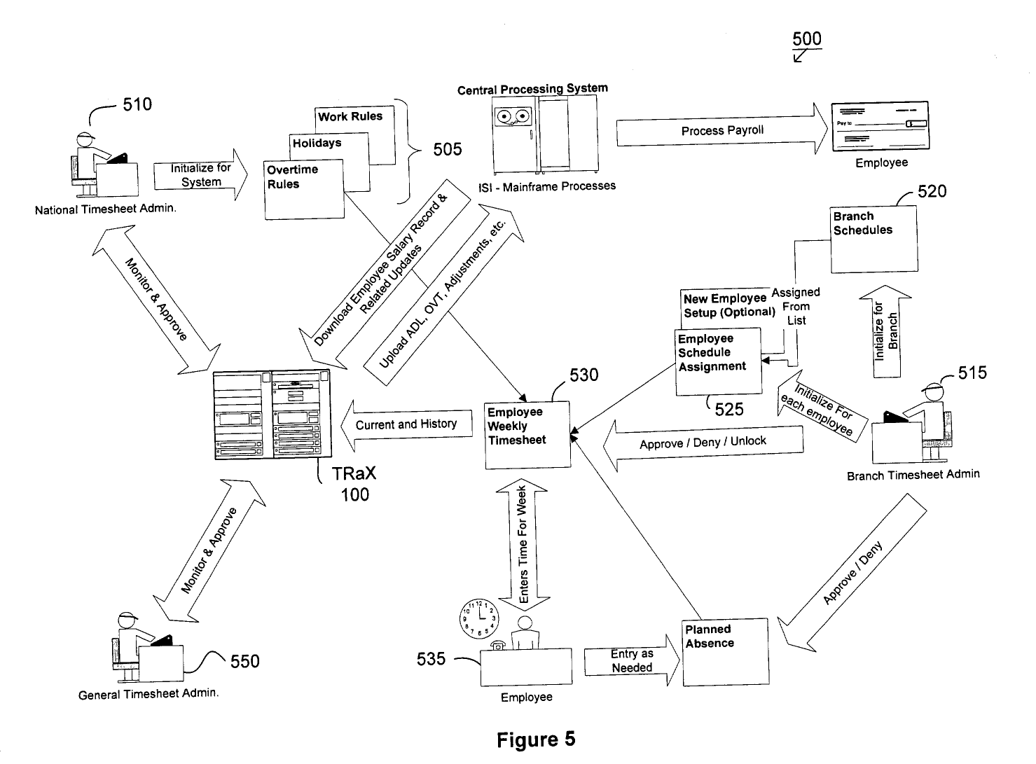

FIG. 5 illustrates the flow of time entry and approval information throughout the TRAX 100 system according to at least one embodiment of the present invention. For initial deployment, the central processing system 104 may download to the web server 102 employee data and reference information such as, but not limited to, employee information and cost center information contained in the employee records 109. The web server 102 may cause this downloaded information to be stored using the timesheet database 108. The web server 102 may make certain of this information available to the computing device 101. The central processing system 104 may review the employee data and reference information provided to the web server 102 on a periodic basis to determine the presence of additions/deletions/changes. In accordance with at least one embodiment, the frequency of the update determination may be made once per 24 hour period. Alternatively, the update process may be executed weekly. Any such changes different from the existing distributed copy of this information may be downloaded by the central processing system 104 to the web server 102 as delta or change information. Limiting updates to the delta population reduces processing time and volume. An additional part of the periodic process may be a feedback file used to update distributed pay records with the “paid” date and schedule numbers. Deviations from the distributed system payment calculation may also be downloaded from the central processing system 104 to the web server 102 and noted on the employee's time record. This download may be performed periodically, such as once per pay period.

The employee data and reference tables transmitted by the central processing system 104 may be augmented by additional reference and control data 505 created and maintained by the NTA 510 and distributed using a network. The reference and control data 505 may include absence types lists, holiday dates table, other work rules, and overtime rules.

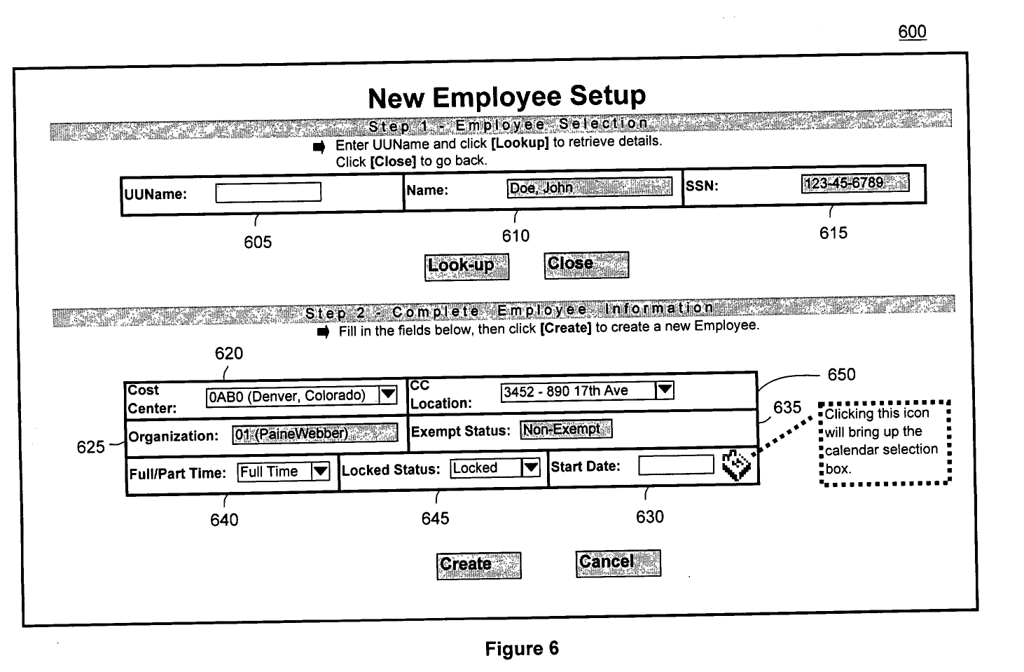

In addition, the BTA 515, GTA 550, or other administrative user may enter new employee information by interacting with a new employee setup page 600 as shown in FIG. 6. In accordance with at least one embodiment, the computing device 101 may request the new employee setup page 600 from the web server 102 upon user selection of a corresponding button or hyperlink, for example, of an interactive page displayed to the user by the computing device 101. In response to receiving this request, the web server 102 may dynamically create the interactive page by using process code residing on the web server 102 and data from the database server 103 in the manner described herein, and then the web server 102 may transmit the new employee setup page 600 to the computing device 101 of the requesting user. Upon receiving the interactive page information from the web server 102, the computing device 101 may cause the new employee setup page 600 to be displayed to the requesting user.

The above process may be used generally for each page described in reference to FIGS. 6 through 15. In accordance with at least one embodiment, the computing device 101 may request a particular page from the web server 102 upon user selection of a corresponding button or hyperlink, for example, of an interactive page displayed to the requesting user by the computing device 101. In response to receiving this request, the web server 102 may dynamically build the interactive page in the manner described herein, and then the web server 102 may transmit the page to the computing device 101 of the requesting user. Upon receiving the interactive page information from the web server 102, the computing device 101 may cause the page to be displayed to the requesting user.

Referring to FIG. 6, the new employee setup page 600 may include a unique employee identifier 605 (e.g., “UUName”), the employee's name 610, the employee's social security number 615, a cost center 620, a cost center location 650 associated with the new employee, an organization 625 associated with the new employee, a date for the new employee's scheduled first day working in the cost center 630, an indication of salaried status 635, a full or part time status indicator 640, and a locked/unlocked compensable hours indicator 645. The salaried status 635 may specify whether or not the new employee is exempt from overtime compensation or is non-exempt and therefore must be compensated for overtime, in accordance with state compliance. In at least one embodiment, the cost center 620 may be a designated accounting group, which could include all or part of one or more cost center locations 650.

The BTA 515 may be responsible for creating the various branch work schedules 520 utilized by their branch for employees associated with that branch, and for assigning those schedules to individuals in an employee schedule assignment 525. Examples of the branch work schedules 520 include: “full time, 9-to-5, Monday through Friday” or “part time, 10-to-4 Monday, Wednesday, and Friday.” In at least one embodiment, description fields on the database may be limited to 30 characters in length. The employee schedule assignments 525 may be assigned to multiple individuals at the branch.

In at least one alternative embodiment, employee work schedules may be established on a companywide basis or another basis such as a nationwide basis. For these embodiments, the BTA 515 may assign the pre-defined employee work schedules to employees, while local BTA 515 creation of employee work schedules is not automated by the computing device 101.

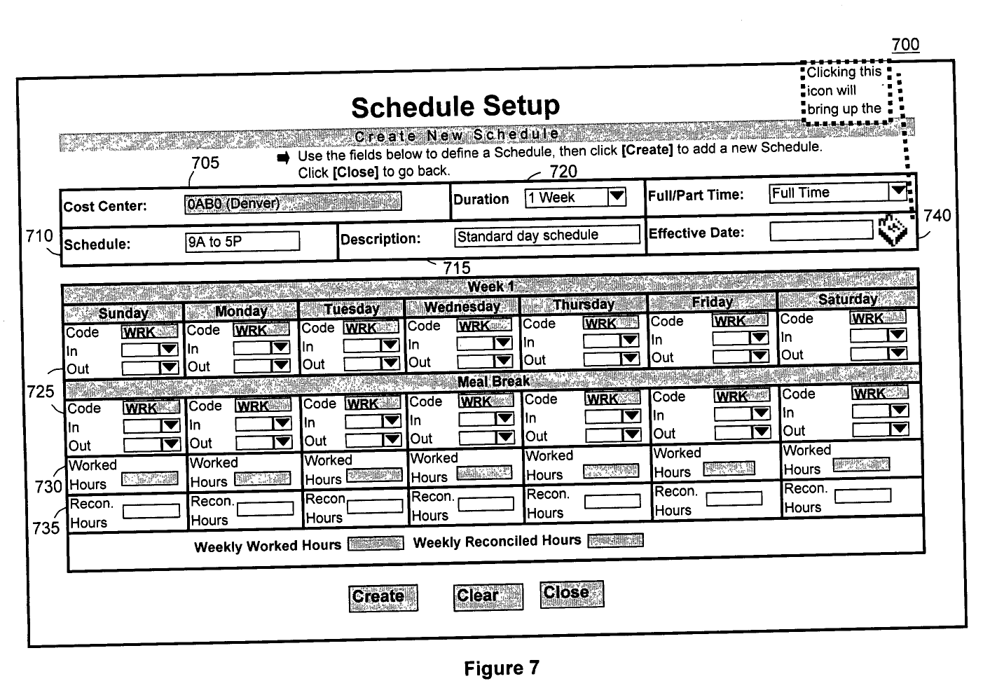

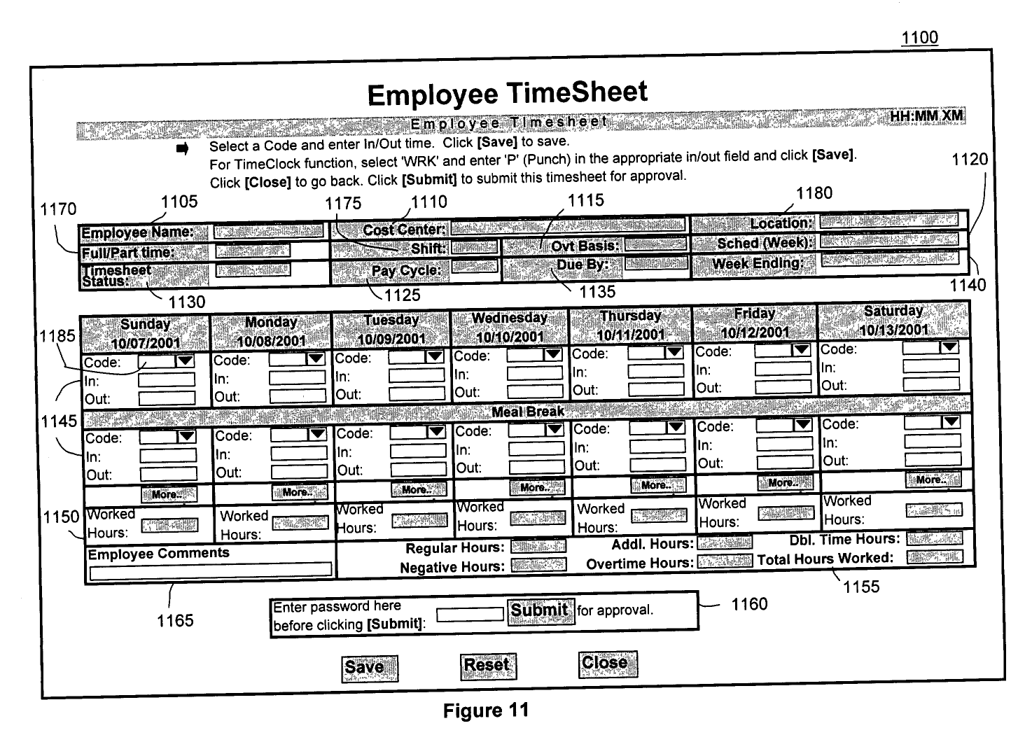

FIG. 7 illustrates a schedule setup page 700 provided by the TRAX 100 system in accordance with at least one embodiment of the invention with which the BTA 515 may interact using the computing device 101 to establish a work schedule 520. Referring to FIG. 7, the schedule setup page 700 may include a cost center indicator 705, a schedule identifier 710, a long schedule description 715, a duration indicator 720, a time in/out standard 725 for each day of the schedule, a worked hours field 730, a recompensable hours field 735, and an effective date field 740. In accordance with at least one embodiment, the cost center indicator 705 may be used to specify a particular organization for which the schedule is meant to apply. The cost center indicator 705 may be an alphanumeric value that uniquely identifies a particular cost center. The schedule identifier 710 may provide a short description of a particular schedule, while the long schedule description 715 may provide a longer, freeform text description of the schedule (e.g., “standard day schedule”). The duration indicator 720 may specify the number of reporting weeks (e.g., one or two) included in the schedule. The time in/out standard 725 may specify the preferred or required daily start and stop times for an employee bound to follow the schedule. Two pairs of in/out time standards 725 may be provided, the pair-broken by a meal break. The worked hours field 730 may specify the daily number of hours expected to be worked, and the recompensable hours field 735 may specify the corresponding number of hours for which an employee should be compensated. In at least one embodiment, the daily worked hours field may be computed from the time difference between in/out punches. The worked hours 730 and recompensable hours 735 may or may not be equal to one another. In at least one embodiment, the TRAX 100 system may generate a report in the event that the worked hours 730 equal the recompensable hours 735. The worked hours 730 may be compared to the recompensable hours 735 to determine whether the meal allowance is due as described later herein with respect to FIG. 11. In particular, an employee may be granted the meal allowance if the employee has worked a predetermined minimum number of hours. The effective date field 740 may specify a date when a schedule can start to be used. By saving schedule setup pages 700 with different dates in the effective date field 740, multiple versions of the same schedule may be maintained.

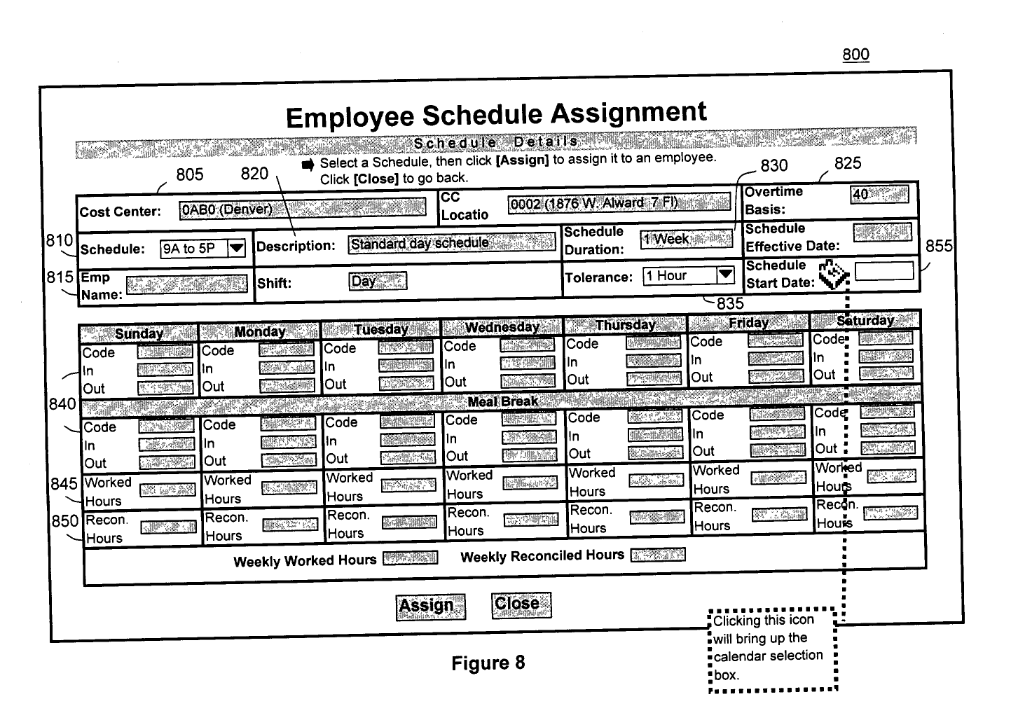

FIG. 8 illustrates an employee schedule assignment page 800 provided in accordance with an embodiment of the TRAX 100 system with which the BTA 515 may interact using the computing device 101 to establish an employee schedule assignment 525. Referring to FIG. 8, the employee schedule assignment page 800 may include a cost center indicator 805, a schedule identifier 810, an employee name 815, a long schedule description 820, an overtime basis indicator 825, a duration indicator 830, a tolerance 835, a time in/out standard 840 for each day of the schedule, a worked hours field 845, a compensable hours field 850, and a schedule start date field 855. In accordance with at least one embodiment, the cost center indicator 805 may be used to specify a particular organization for which the schedule is meant to apply. The cost center indicator 805 may be an alphanumeric value that uniquely identifies a particular cost center. The schedule identifier 810 may provide a short description of a particular schedule, while the long schedule description 820 may provide a longer, freeform text description of the schedule (e.g., “standard day schedule”)., The employee name 815 may be used to specify the employee to which the employee schedule assignment 525 is to be applied. In at least one embodiment, more than one work schedule (identified using the schedule identifier 810) may be assigned for future application to a user. The overtime basis 825 may include an indication of the hours and period for calculation with respect to which overtime compensation is to be determined. The duration indicator 830 may specify the number of reporting weeks (e.g., one or two) included in the schedule. The tolerance 835 may specify a range within which actual daily worked in/out time may deviate from the scheduled in/out time before a counter is incremented. A tolerance indicator may provide a count of the number of times an employee has exceeded the tolerance range to provide an indication of how closely an employee is following his schedule. The time in/out standard 840 may specify the preferred or required daily start and stop times for an employee bound to follow the schedule. Two pairs of in/out time standards 840 may be provided, the pair broken by a meal break. The worked hours field 845 may specify the daily number of hours expected to be worked, and the recompensable hours field 850 may specify the corresponding number of hours for which an employee should be compensated. The worked hours 845 and recompensable hours 850 may or may not be equal to one another. The schedule start date field 855 may specify a date when an employee can start to use the associated schedule. By saving schedule assignment pages 800 with different dates in the schedule start date field 855, multiple future dated schedule assignments may be provided. In at least one embodiment, fields related to the schedule characteristics (e.g., times and hours) may be for display purposes only and can only be updated by the schedule setup 700.

In addition to creating and assigning work schedules, the BTA 515 may also be responsible for approving employee requested planned absences and approving the employee timesheets 530. In accordance with at least one embodiment, only approved timesheets 530 may be forwarded to the central processing system 104 for further processing. The TRAX 100 system may provide multiple interactive pages which the BTA 520 may indicate timesheet 530 approval, ranging from a workweek summary view (which may contain a single line of data for each employee) to the employee's detail work schedule. After the weekly timesheet 530 has been approved, the TRAX 100 system provides the BTA 520 the ability to adjust the allocation of the employee's time between financial advisors (FA splits) and to grant additional premium payments. Historical payment records may also be adjusted by, for example, appending adjustment information to the historical record. The BTA 515 may also have the ability to enter time on behalf of an employee and to submit the associated timesheet for processing.

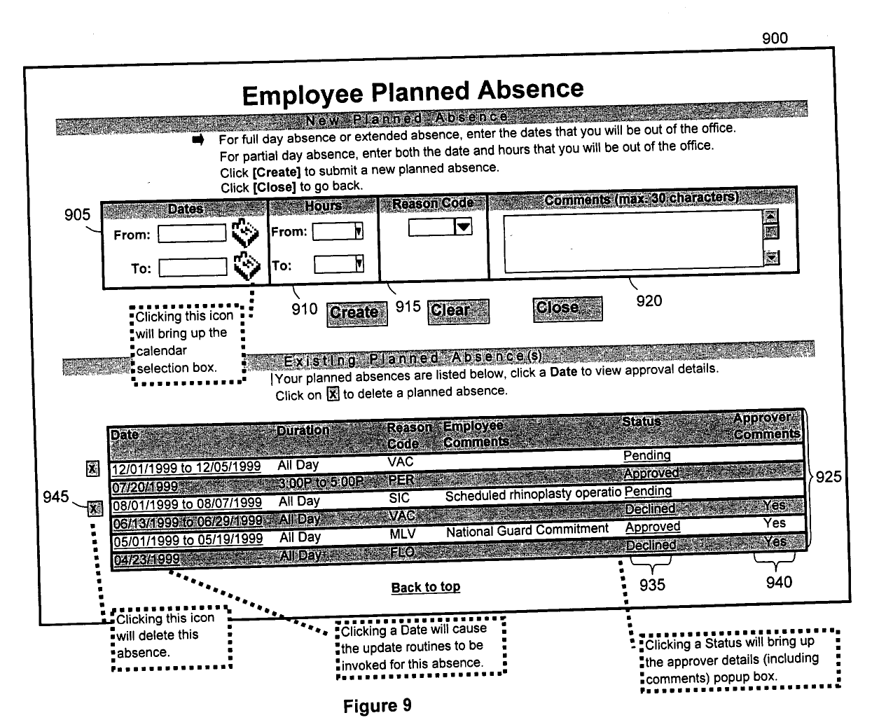

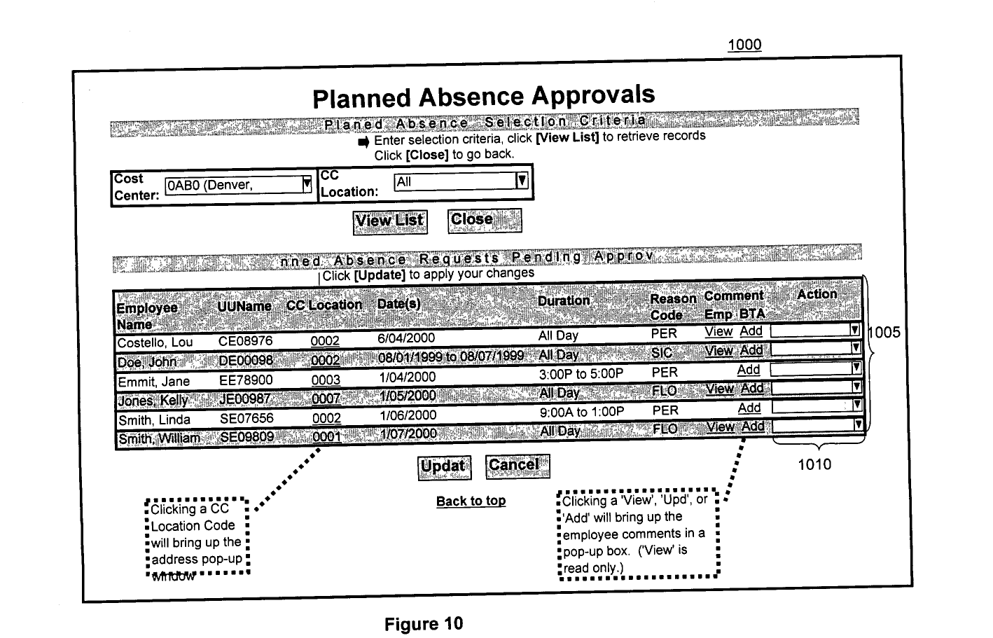

The TRAX 100 system may provide employees 535 with the capability to schedule planned absences and enter time worked for a time reporting period, such as a workweek. The planned absence functionality permits the processing of an employee's timesheet 530 even though the employee herself may be absent from the office. FIG. 9 illustrates an employee planned absence page 900 provided in accordance with an embodiment of the TRAX 100 system with which employees 535 may interact using the computing device 101 to request a planned work absence. FIG. 10 illustrates a planned absence approvals page 1000 provided in accordance with an embodiment of the TRAX 100 system with which the BTAs 515 may interact using the computing device 101 to request a planned work absence. Referring to FIG. 9, the employee planned absence page 900 may include a from/to date request field 905, an hours field 910, a reason code 915, comments 920, and a planned absences list 925. The from/to date request field 905 may provide an interactive data entry field in which the requesting user may enter the dates of his requested planned absence. The hours field 910 may provide an interactive data entry field in which the requesting user may enter the time of his planned absence for a particular day, or for all day. The reason code 915 may provide an interactive data entry field for a user to enter an alphanumeric code, or other code format, selected from among multiple individual codes each of which uniquely identify a reason for the planned absence. In accordance with at least one embodiment, a user may view the set of reason codes be selecting a pull down menu associated with the reason code 915 field. The comments 920 may provide a data entry field in which the requesting employee may enter descriptive comments detailing the reasons for the planned absence. The planned absences list 925 may present a list of recent planned absences for the requesting user. The planned absences list 925 may include, for each planned absence, information from each of the data entry fields described above in addition to a status 935 for each request indicating whether the request has been approved or declined, and approver comments 940. A checkbox 945 may also be included for each entry in the planned absences list 925 which may allow the deletion of a pending future dated planned absence.

Referring to FIG. 10, the planned absence approvals page 1000 may include a planned absences list 1005 selected for and corresponding to a particular requesting employee associated with a particular cost center, and similar to that of FIG. 9. However, the planned absences list 1005 may further include an interactive action field 1010 by which a BTA 515 may take action on the request by entering one of at least an approval code or a denial code and may enter descriptive comments detailing the reasons for their approval/denial action. After a BTA 515 takes action on a planned absence request, this disposition may be reflected in the status 935 field and approver comments 940 field of the planned absences list 925 of FIG. 9.

In accordance with at least one embodiment, employees 535 may enter their time worked at the computing device 101 using a timesheet 530, which may be an interactive page. FIG. 11 illustrates an exemplary timesheet page 1100 provided by an embodiment of the TRAX 100 system. Referring to FIG. 11, the employee timesheet page 1100 may include an employee name 1105, a cost center indicator 1110, a cost center location 1180, full/part-time employee indicator 1170, employee shift indicator 1175, an overtime basis indicator 1115, a schedule identifier 1120 and associated week number (indicating that the schedule is in the first or second week of a two week (duration) schedule), a week ending date 1140, a pay cycle indicator 1125, a timesheet status indicator 1130, a timesheet due date indicator 1135, time in/out log 1145 for each day of the reporting period, a worked hours field 1150, an hours summary 1155, a submit button 1160, and an employee comments field 1165. The employee name 1105 may be used to specify the employee to which the timesheet 530 pertains. The cost center indicator 1110 may be used to specify a particular organization location associated with the submitting employee. The cost center indicator 1110 may be an alphanumeric value that uniquely identifies a particular cost center. The overtime basis 1115 may include an indication of the hours and period for calculation with respect to which overtime compensation is to be determined. The schedule identifier 1120 may provide a short description of the schedule that applies to the employee entering the time entry data for a particular cost center. The pay cycle indicator 1125 may specify a code (e.g., an alphanumeric code) that uniquely identifies a particular pay cycle (e.g., ‘08’). The timesheet status 1130 may provide an indication of whether or not the timesheet 530 has been submitted, not yet submitted, approved, or declined. The timesheet due date indicator 1135 may indicate the date by which the timesheet 530 should be submitted by the entering employee. The cost center location 1180 may specify a geographic location within the cost center 1110. The full/part-time employee indicator 1170 may be a binary value indicating whether or not the employee works a full-time or part-time schedule. The employee shift indicator 1175 may provide an indication of which shift (in a cost center 1110 having multiple shifts) the employee works.

Furthermore, the time in/out log 1145 may provide at least two pairs of “in” and “out” interactive fields in which an employee can enter her time in and time out, e.g. in a timeclock fashion, for a work day, using a data entry device of the computing device 101. For each pair of in/out punches, the employee may also designate a time code 1185 to be associated with the punches (work, sick, vacation, etc.). At least one break may be provided between two pairs of in/out log fields. In accordance with at least one embodiment, two in/out punches for each day of the week (e.g., Sunday through Saturday) may be provided, while additional in/out punches (to a maximum of four, for example) may be added to each day. In at least one embodiment, the time in/out log 1145 may not be updated for ‘work’ associated times by an employee user if the employee is associated with a cost center 1110 corresponding to one of a subset of cost centers for which ‘work’ time in/out update is prohibited. These ‘timeclock’ related cost centers may only allow the entry of ‘work’ related time by entering a ‘P’ in the in/out log fields 1145. Using the server time, the system may determine the associated local time for the user and enter that time into the appropriate field. A user may select additional pairs of in/out punches by selecting a button provided for this purpose (e.g., “More . . . ”). The worked hours field 1150 may indicate the daily total number of hours worked by the entering user. In at least one embodiment, daily hours for codes such as ‘work’ or ‘vacation’ may be calculated by the timesheet page application 400 by determining the time between in/out punches and rounding to the next highest ¼ hour. The hours summary 1155 may provide summary indications for the time entered by an employee using a timesheet page 1100 for the reporting period covered by the timesheet 530, including, but not limited to, the total number of regular hours, negative hours, additional hours, overtime hours, double time hours, and grand total hours. These hours may be determined based upon the hours represented on the timesheet, the schedule to which the employee was assigned, and the overtime basis associated with the employee. The TRAX 100 system may also use this information to calculate ‘meal allowance’ and grant overtime for time worked on ‘non-scheduled’ work days (e.g., weekends) (see earlier discussion regarding meal allowance with respect to FIG. 7). The submit button 1160 may provide the user the capability to request the computing device 101, via data entry device, to accept the populated timesheet page 1100 containing the user's entered information, and to upload the time entry data to the web server 102. The timesheet page 1100 may provide additional buttons such as, but not limited to, an update button, a reset button, and a cancel button. Finally, the employee comments field 1165 may provide a user with the capability to enter descriptive freeform text to inform the BTA 515 or other administrative user of certain textual information that may be relevant to the timesheet 1100. In at least one embodiment, the TRAX 100 system may also compare the first in and last out punches for each scheduled ‘work’ day to determine if the tolerance count must be incremented (reference earlier discussion with respect to FIG. 8 regarding the tolerance indicator). Furthermore, fields in time in/out log 1145 may be used to enter time in hours and minutes and in AM or PM or military designation. All time thus entered may be considered local and not associated with a timezone. The TRAX 100 system may accept abbreviated designations for time and translate them into hours and minutes (e.g., ‘11’, ‘11a’, ‘11am’ are all translated into ‘11:00 AM’).

Upon initial presentation, the timesheet page 1100 may be preloaded with holidays (if they occur on a scheduled work day for the employee) or pre-planned ‘approved’ absences that occur during the reporting period or workweek. Such preloaded data may be overtyped if the employee did not take the requested planned absence. Time worked on a holiday may be entered as additional time in/out log 1145 punches. After the employee 535 has entered all of their time for the reporting period, they may submit the timesheet 530 for approval by the BTA 515 by entering their password and selecting the submit button 1160. Once submitted, the TRAX 100 system may prohibit the employee 535 from updating the submitted timesheet 530. If after submission, the employee needs to modify the timesheet 530, the employee 535 may request that the BTA 535 change the timesheet status to “unlock” using the computing device 101. The TRAX 100 system may accept employee changes (for users having user level access) for timesheets 530 having an “unlock” status.

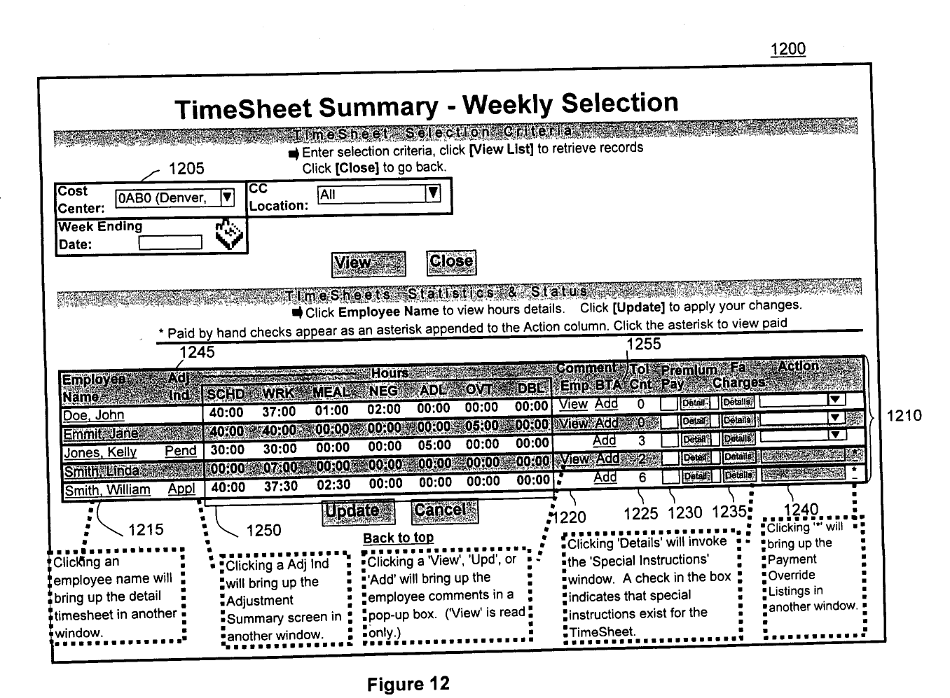

Furthermore, the TRAX 100 system may include interactive pages for entering and reporting timesheet approval status. For example, FIG. 12 illustrates an exemplary timesheet status summary page 1200 in accordance with an embodiment. Referring to FIG. 12, the timesheet status summary page 1200 may provide a timesheet approval summary 1210 of the timesheets entered for a particular cost center, identified using the cost center identifier 1205. Each entry in the timesheet summary 1210 may include individual timesheet 530 information including an employee name 1215, an historical adjustment indicator 1245, summary of hours 1250 associated with the timesheet, an employee comments indicator 1220, a BTA comments indicator 1255, a tolerance count 1225, a premium pay indicator 1230, a revised Financial Advisor (FA) charges indicator 1235, and an interactive action identifier 1240 (which may include a ‘paid by hand check’ indicator). The employee name 1215 may be hyperlink text indicating the timesheet submitter's name. The employee name 1215 hyperlink may be formatted in accordance with the HTTP protocol. User selection of the employee name 1215 may cause the timesheet approval detail page 1300 to be displayed using the computing device 101. The employee comments indicator 1220 may be a hyperlink binary indicators specifying whether or not the submitting employee entered comments 1165 when submitting the associated timesheet 530. User selection of a “View” employee comments indicator 1220 may cause a pop-up box containing the comments 1165 to be displayed. The tolerance count 1225 may be a numeric indicator specifying in how many time in/out log 1145 punches the entered actual time worked deviated from the planned schedule for the employee. The premium pay indicator 1230 may include a checkbox and a “details” button. If the checkbox is checked, special timesheet instructions are indicated and may be viewed or updated by user selection of the “details” button. If the checkbox is unchecked, premium pay may be added by user selection of the ‘details’ button. The revised FA charges indicator 1235 may also include a checkbox and a “details” button that operate similarly as for the premium pay indicator 1230. The interactive action identifier 1240 may indicate what, if any, approval action has been taken by a BTA 515 for the associated timesheet 530. The BTA 515 or other administrative user may enter one of at least an approval code or a denial code using the interactive action identifier 1240, which may further include a pull down menu outputting a set of approval codes from which to choose. The BTA comments field 1255 may provide a user with a hyperlink to a pop-up box allow them to enter descriptive freeform text to document information that may be relevant to timesheet approval.

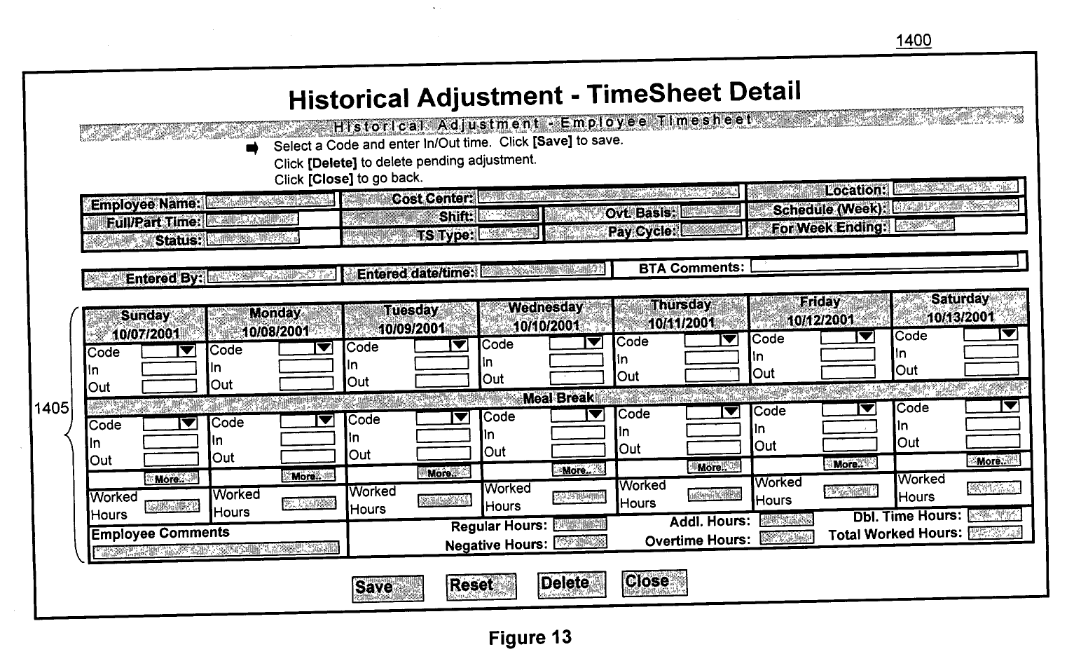

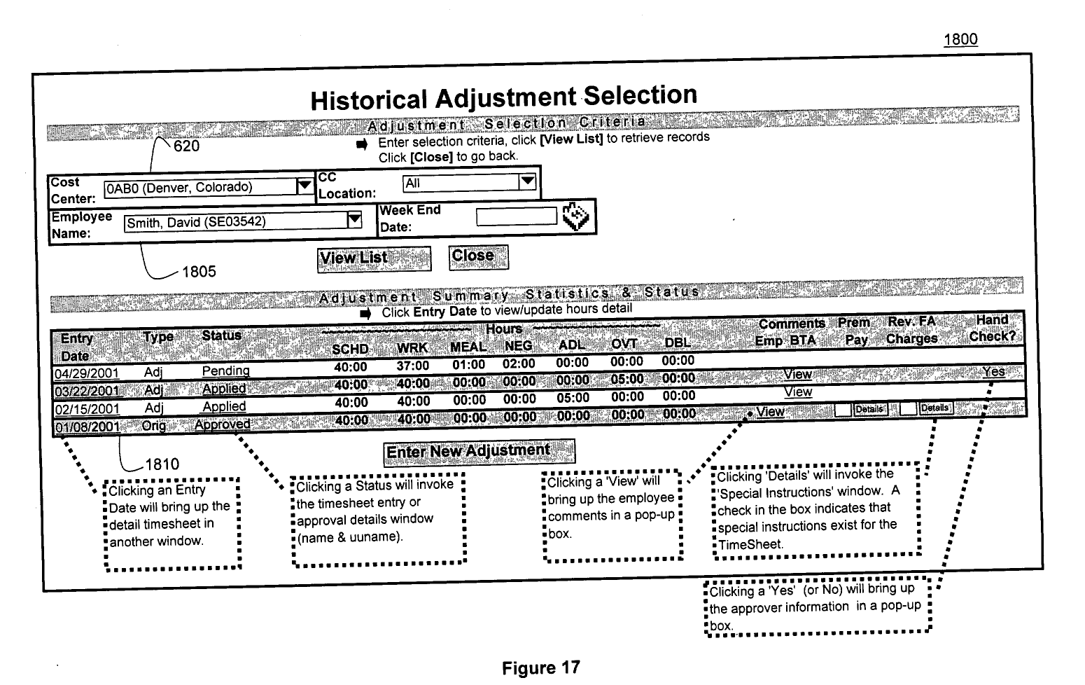

A historical adjustment selection page may be provided similar to the weekly timesheet approval page, but containing a listing for the original timesheet being adjusted, and all subsequent adjustments. The historical adjustment selection page may be used to add new adjustment, update or delete pending adjustments, and display original timesheets and adjustments that have been applied. In at least one embodiment, the TRAX 100 system may include the historical adjustment selection page 1800 as shown in FIG. 17. Referring to FIG. 17, an exemplary historical adjustment selection page 1800 may allow a user to review and enter timesheet adjustments by employee name 1805 at a particular cost center 620, for example. The historical adjustment selection page 1800 may include an adjustment status advising the user of the status of a particular adjustment such as, but not limited to, Pending or Applied. (Pending adjustments have not yet have been applied. Applied adjustments have already taken effect.) The status column also shows the status of the ‘original’ timesheet. The historical adjustment selection page 1800 may include additional interactive data fields as described earlier herein with respect to other figures such as, for example, FIG. 12. A user may choose to enter a new adjustment by-activating an associated button 1815, and entering the adjustment information in the historical adjustment detail page FIG. 13.

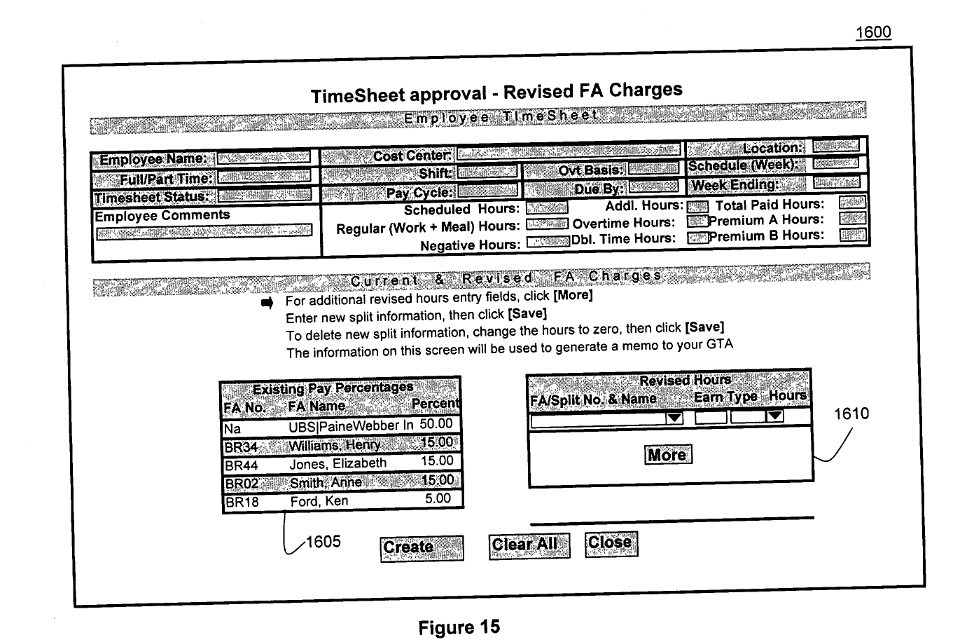

Furthermore, in at least one embodiment the TRAX 100 system may provide the capability for a supervisory or administrative user, such as BTA 515, to revise the allocation of hours associated with FA charges 1605, as shown in FIG. 15. FIG. 15 illustrates an example of timesheet approval—revised FA charges page 1600 provided in accordance with at least one embodiment. Referring to FIG. 15, the TRAX 100 system may provide the capability for a user to specify the revised hours for a particular FA by, for example, entering the revised hours portion using an interactive field such as the revised hours field 1610. The timesheet approval-revised FA charges page 1600 may include additional interactive data fields as described earlier herein with respect to other figures such as, for example, FIG. 11.

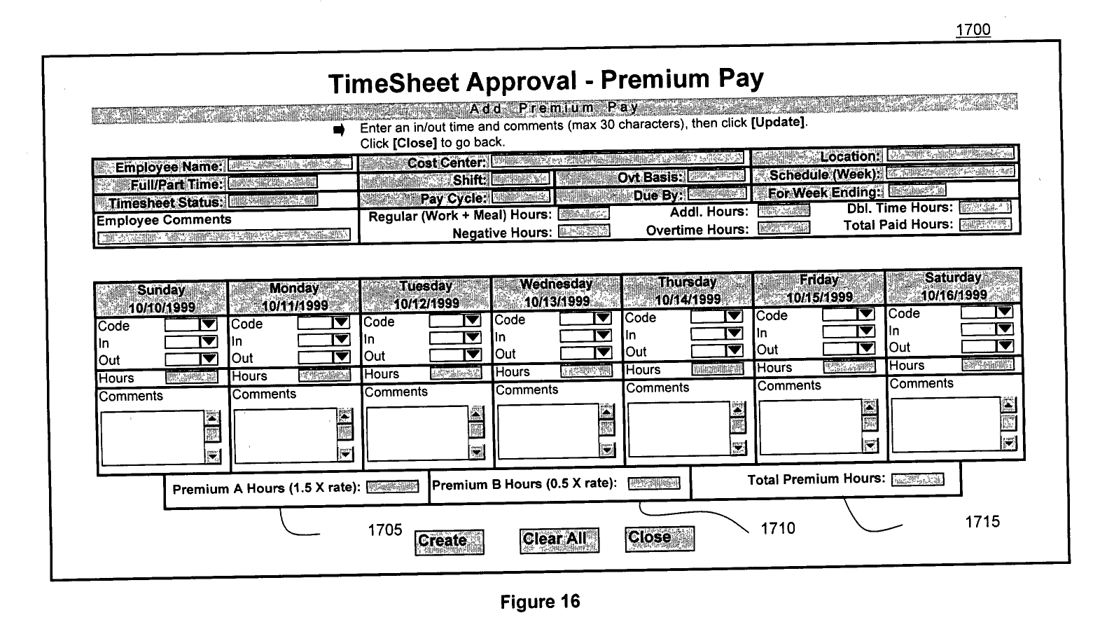

Still further, in at least one embodiment the TRAX 100 system may provide the capability for a supervisory or administrative user, such as BTA 515, to specify premium pay to be given in compensation to a particular employee, as shown in FIG. 16. FIG. 16 illustrates an exemplary timesheet approval—premium pay page 1700 provided in accordance with at least one embodiment. Referring to FIG. 16, the TRAX 100 system may provide the capability for a user to specify one or more premium pay rates to be applied separately to a portion of an employee's hours worked. For example, a “Premium A rate” of 1.5 times the employee's regular compensation rate may be applied to a portion of the hours worked by entering the application hours portion using an interactive field such as the “Premium A” field 1705. Furthermore, a “Premium B rate” of 0.5 times the employee's regular compensation rate may be applied to a portion of the hours worked by, for example, entering the application hours portion using an interactive field such as the “Premium B” field 1710. The timesheet approval-premium pay page 1700 may also include an indication of the total number of premium pay hours 1715. The timesheet approval—premium pay page 1700 may include additional interactive data fields as described earlier herein with respect to other figures such as, for example, FIG. 11 with the exception that the time codes associated with the punches may be limited to PRA (premium A) and PRB (premium B).

Furthermore, a timesheet approval detail page may be provided showing detailed information for a timesheet 530 as approved by the BTA 515. As such, the timesheet approval detail page may include much of the information also provided for the timesheet page 1100, including, but not limited to, employee name 1105, the cost center indicator 1110, the overtime basis indicator 1115, the schedule identifier 1120, the pay cycle indicator 1125, the timesheet status indicator 1130, time in/out log 1145 for each day of the reporting period, the worked hours field 1150, and an hours summary 1155. The timesheet approval detail page may include additional fields as described with respect to timesheet page 1100 (ref. FIG. 11). However, the timesheet approval detail page may be for display only and may not include any updateable Fields.

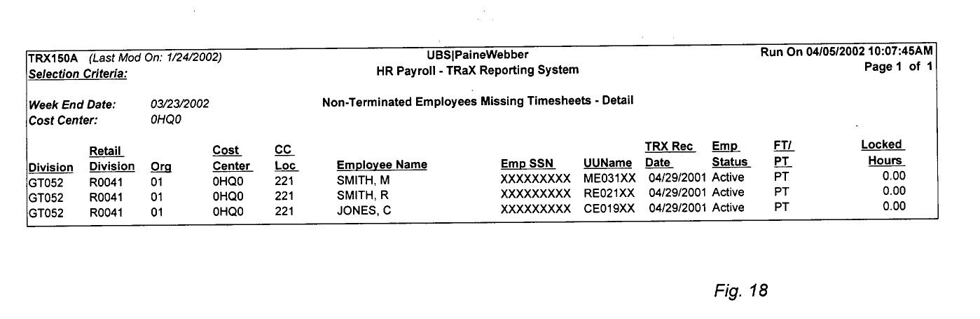

Regarding the historical time adjustment capability provided by an embodiment, FIG. 13 is an exemplary historical adjustment detail page 1400. Referring to FIG. 13, the historical adjustment detail page 1400 may include the same information as the timesheet detail page 1100 of FIG. 11, with the exception of the addition of BTA ‘entered by’ name, BTA ‘entered date/time’, BTA comments, and revised time codes and associated punches 1405. Updates to the historical time detail page 1400 may follow the same rules as updates for timesheet detail page 1100 except that there may be no submit button. Instead, updates may be accomplished by providing a ‘save’ button. The historical time detail page 1400 may be accessed via an historical adjustment summary page (see FIG. 18).

To facilitate user communication and notification, the TRAX 100 system may, in various embodiments, utilize at least three methods of communication. First, all timesheet 530, planned absence, and approval records can be annotated with comments. Second, the web server 102 may automatically generate alerts (e.g., short informational messages). In at least one embodiment, the user will be notified via an alert count that they have a pending alert, and the user can then request to view it using, for example, the pointing device 230. An alert may be generated whenever the TRAX 100 system determines the need for user action, or alternatively or additionally, when an administrative user enters and requests transmission of an alert. For example, the web server 102 may generate and transmit an alert notification to the BTA 515 that a timesheet 530 has been submitted and awaits approval. Third, the TRAX 100 system may provide reports, including both predefined reports and parameter driven reports.

It should be understood that time schedules and payment cycles may be processed and treated according to different time bases. In particular, the time reporting period or time duration may be treated differently depending upon whether it is referenced from a distributed or online process, such as that provided by the web server 102 and the computing device 101 of the present embodiment, or from a central processing system 104 or mainframe process. For example, distributed or online time entry, reporting, and extraction processes and procedures including, but not limited to, building schedules, inputting time, and approving the final timesheet, may be based on and developed around the concept of a workweek (e.g., seven days, Sunday through Saturday). A workweek is one of the oldest time reporting metaphors, and is easy to use and understand for scheduling and tracking purposes. Mainframe system processing however, may be driven by the constraints of payment cycles. Distributed and mainframe processes are complementary as long as both scheduling and payment cycles utilize corresponding weekly or bi-weekly timeframes. However, introduction of a semimonthly pay cycle for hourly employees may make it problematic for employees to use the pay cycle metaphor as the basis for scheduling. Such semi-monthly pay cycles may begin on different days of the week and contain varying number of workdays depending upon how the weekends fall within the month. The TRAX 100 system according to at least one embodiment of the present invention resolves this problem by allowing online scheduling and time reporting to continue as a weekly process, converting the weekly data to regular/additional/overtime records, and then uploading a variable number of weekly records (depending upon the payroll schedule) to the central processing system 104. This technique therefore allows for traditional scheduling and time reporting in the distributed or online environment, while supporting a variety of pay cycles on a central processing system or mainframe.

In accordance with at least one embodiment, the TRAX 100 system may transmit or upload from the database server 103 to the central processing system 104 approved timesheet 530 records. The upload may be a sweep of all approved timesheet 530 records at a database server 103. Additionally, in at least one embodiment, prior to upload the TRAX 100 system may convert the uploaded records from a workweek time basis to a payment type format suitable for processing by the central processing system 104 In at least one embodiment, this conversion/calculation may be performed in real-time on-line. Alternatively, the conversion/calculation may be performed in batch mode. This conversion and upload may be provided on a scheduled basis, the schedule depending upon whether overtime or pay period records are required, for example. The schedule may be periodic, such as a daily upload schedule. Alternatively, the time basis conversion may be accomplished by an administrative user who, using an editing capability, modifies the uploaded approved timesheet records to the format required by the central processing system 104. The editing capability may be provided by the web server 102, or by an external system. The converted records may then be provided to the central processing system 104 for further processing (e.g., payroll processing) by transmitting the converted records from the web server 102 to the central processing system 104 using a communications link. Alternatively, the web server 102 may generate a converted records report which is subsequently provided to the central processing system 104 via communication link, or conveyed in hardcopy form to the central processing system 104 personnel for input.

When the event being processed includes payment for overtime/additional pay, TRAX 100 records may bevalidated against information contained in the employee records 109 to ensure, among other things, that the current organization is recorded. The TRAX 100 records may then be converted into central processing system 104 transactions (using transaction creation application module 410) to be processed by the central processing system 104 in a payroll. Alternatively, conversion of TRAX 100 records may be accomplished by an administrative user who, using an editing capability, modifies the TRAX records to the format required by the central processing system 104. The editing capability may be provided by the web server 102, or by an external system. In particular, the editing capability may be provided by a file text editor. The converted records may then be provided to the central processing system 104 for further processing (e.g., payroll processing) by transmitting the converted records from the web server 102 to the central processing system 104 using a communications link. Alternatively, the web server 102 may generate a converted records report which is subsequently provided to the central processing system 104 via communication link, or conveyed in hardcopy form to the central processing system 104 personnel for input. In at least one embodiment, the TRAX 100 system may provide the NTA 510, BTA 515, or GTA 550 the capability to enter/modify employee time and submit the timesheet for processing on behalf of the employee. In doing so, the TRAX 100 system may automatically recalculate all payment data (overtime, negative time, etc.). In at least one embodiment, the NTA 510, BTA 515, and GTA 550 may not have TRAX 100 editing capability against payment type records.

When the event processed includes regular period pay, the employee records 109 may be used by the central processing system 104 to create what will be generated from an auto pay application module of the central processing system 104. The central processing system 104 may then compare the regular period pay amounts against the TRAX 100 records to determine a match. From this matching process, additional central processing system 104 transactions may be created. In at least one embodiment, the TRAX 100 system may only upload records which will cause a modification to the regular pay calculation performed by the central processing system 104 (e.g., overtime, doubletime, additional ‘regular’ pay for part-time locked employees, and negative reductions in pay if not all of the contractual hours were accounted for). The only regular pay that may be uploaded by the TRAX 100 system is for employees who do not work a set number of hours per week. The TRAX 100 system may upload records reflecting deviations from the regular pay amount. The central processing system 104 may use reserved batch numbers to easily identify TRAX 100 payment records from other payroll department activity. Processing the records in this way provides payroll department staff the ability to view transactions using an existing payroll processing application module of the central processing system 104. This provides payroll personnel the ability to modify records using the central processing system 104, if required, and make any adjustments deemed necessary. In accordance with at least one embodiment, once the TRAX 100 system initially sweeps the approved TRAX 100 records, they may not be revised by a BTA. If a circumstance requires intervention, at this point only a payroll staff member may have the ability to alter a time record using the TRAX 100 system and have that record uploaded on a second or third sweep. Once the third and final sweep is made, records may only be modified within the TRAX 100 system using the historical adjustment process.

The central processing system 104 may execute a scheduled payroll run, which may be a mainframe batch process, to process the time transactions and produce pay period checks and advise. This exemplary schedule fulfills a statutory requirement that payment for overtime hours worked take place within 10 calendar days of a period end. Regular events may be scheduled around the period pay dates. As part of post payroll processing, the central processing system 104 may execute another process (which may be a mainframe batch job) to extract the transactions used to calculate payment and compare them with the incoming transactions from TRAX 100 records.

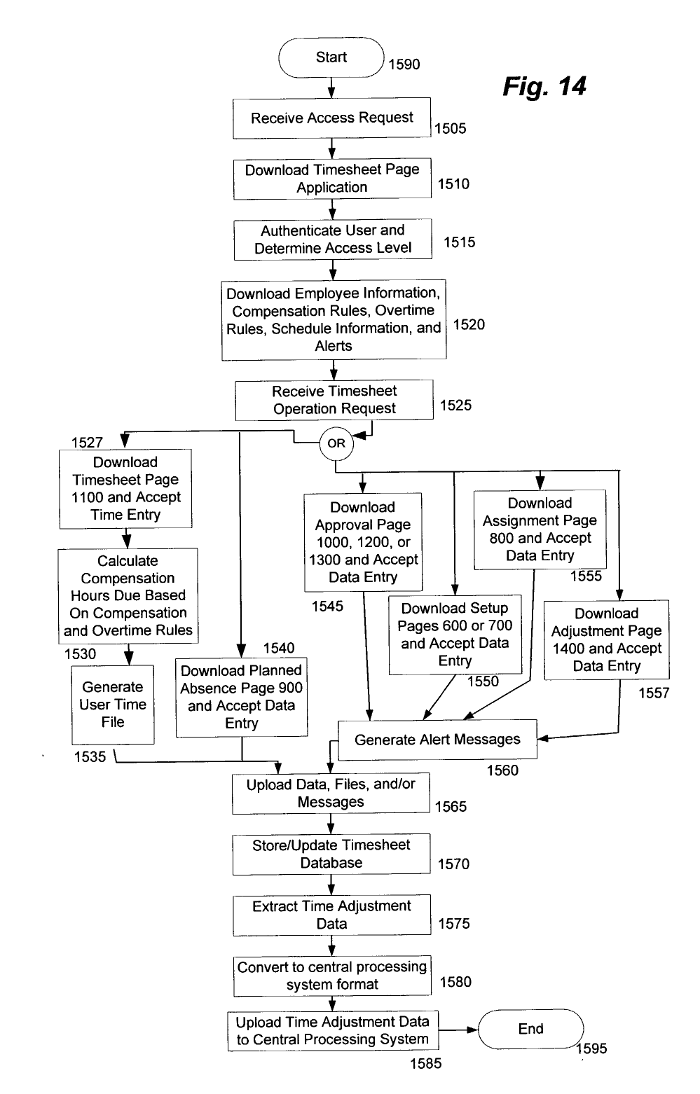

FIG. 14 illustrates a timesheet reporting and extraction method in accordance with at least one embodiment of the invention. As shown in FIG. 14, a timesheet reporting and extraction method 1500 may be initiated at 1590 upon the TRAX 100 system receiving a user access request from the computing device 101 at 1505. To initiate access, a user may enter the URL associated with the web server 102 into the address line of a browser application, which may be a World Wide Web browser application. Alternatively, a user may select an associated hyperlink contained on an interactive page using a pointing device such as a mouse or via keyboard commands. This selection or URL activation may cause the computing device 101 to transmit an HTTP-formatted electronic message to the web server 102 (after Internet domain name translation to the proper IP address by an Internet proxy server) requesting access to the TRAX 100 system. In particular, in response to a user request, the computing device 101 may transmit a message requesting an initial interactive page for accessing the TRAX 100 system to be provided to the computing device 101. The computing device 101 may receive the user request via data entry device upon user selection of an associated hyperlink or upon a user entering a Uniform Resource Locator (URL) address associated with the web server 102 hosting the TRAX 100 system. The computing device 101 may transmit the message requesting access to the TRAX 100 system to the web server 102 as an HTML or XML formatted message in accordance with the HTTP protocol. In response, the web server 102 may, based upon user input and navigation requests, dynamically build the timesheet page and all associated control/edit data and transmit the timesheet page to the computing device 101, at 1510. In at least one embodiment, the timesheet page application 400 may include a combination of HTML and JavaScript instructions residing in the web page itself.

Alternatively, in a client-server embodiment, in response to the user request the web server 102 may download a timesheet application module to the computing device 101 via the network 106 in accordance with the FTP protocol, at 1510.

Upon receiving the timesheet page application 400 code download from the web server 102, the computing device 101 may automatically execute the timesheet page application 400. Upon execution, the timesheet page application 400 may cause the computing device 101 to authenticate the user as having valid access privileges to the TRAX 100 system at 1515. In particular, the web server 102 may generate and transmit an interactive HTTP-formatted client login HTML or XML page (e.g., “welcome” page) to the computing device 101, and establish a session at 1510. The login HTML or XML page may include data entry fields in which a user of the computing device 101 may enter identification or authentication information such as the user's name, employee identification number, password, or other data assigned for use with the TRAX 100 system. Additional client entitlement information may be used in this manner as well.

In accordance with at least one embodiment, the TRAX 100 system may authenticate a user requesting access by comparing certain information provided by the requesting user with corresponding employee information maintained using a security database (which may be employee records 109). In particular, the computing device 101 may transmit an HTTP-formatted message to the web server 102 requesting the employee schedule assigned to the requesting user (for an employee user) for the employee and the cost center associated with the employee. This information may be obtained from the computing device 101 configuration files initialized at the computing device 101 startup. In response to receiving the request, the web server 102 may obtain the associated information from the timesheet database 108.

For accessing information maintained by the timesheet database 108, the web server 102 may formulate a corresponding request for the desired data and transmit the information request to the database server 103. The database server 103 may retrieve and link together one or more scripts designed to access the appropriate corresponding information records contained in the timesheet database 108, which the database server 103 then executes to effect retrieval of the information from the timesheet database 108. In accordance with at least one embodiment, these scripts may include a sequence of SQL instructions.

Referring again to FIG. 14, if the information received from the timesheet database 108 indicates that the requesting user is a recognized user of the TRAX 100 system, then the web server 102 may thereby establish the user as being authenticated at 1515. Further to authentication, the web server 102 may determine, from the timesheet database 108 records, the access level associated with the requesting user.

After successful authentication, the web server 102 may transmit the timesheet page application 400 to the computing device 101 in accordance with, for example, HTTP, for execution by the computing device 101, at 1520. Further information accompanying the timesheet page application 400 download may include the appropriate set of compensation rules, overtime rules and/or other business rules, associated with the requesting user and the user's location as specified by records maintained by the timesheet database 108. For employee users, downloaded information may include an indication of the work schedule currently assigned to the employee user. Upon receiving the timesheet page application 400 from the web server 102, the computing device 101 may execute the timesheet page application 400 to provide the time entry and management functionality described herein, including accepting time entry data entered by an employee or user of the TRAX 100 system.

For an employee user having user level access, the user may request time entry using the computing device 101 executing the timesheet page application 400. In addition, the employee user may request to enter planned absence information or view their current and prior schedule assignments or timesheets. An administrative user may request to approve a timesheet, approve a planned absence, add or modify a work schedule, assign a schedule to an employee, enter time worked on behalf of the employee, generate an historical adjustment, or view employee lists. Both employee and administrative users may view information relating to alerts, BTA assignments, holiday listings, overtime rules listings, and work rule listings. The user may select the desired operation using a data entry device or a pointing device to select the corresponding option of an output page provided by the timesheet page application 400 for this purpose (using a human-machine interface of the computing device 101), at 1525. In response to this selection request, the timesheet page application 400 may transmit a message to the web server 102 requesting the corresponding page. The web server 102 may download an interactive page corresponding to the requested operation. The downloaded page may be populated with employee or user information, cost center information, and schedule information obtained from the timesheet database 108 relevant to the requesting user the requested operation. In addition, the computing device 101 executing the timesheet page application 400 may further check for data entry constraints and exceptions conditions, such as the attempted entry of 10 hours of vacation time on a day that the employee is only scheduled to work 8 hours, or the entry of an incorrect time value (for example 13:13 am). In at least one embodiment, the TRAX 100 system allows more than 24 hours of ‘work’ to be entered for a given day.

For an employee user selecting time entry or timesheet view, the web server 102 may in response obtain the currently assigned schedule for the requesting employee user from the timesheet database 108 and download the timesheet page 1100 to the computing device 101. The user may then interact with the timesheet page application 400 to enter time worked using the timesheet page 1100 as described herein, at 1527. Following user input of time entry data, the timesheet page application 400 may compare the time entry data to a predefined work schedule for the user received from the web server 102 at 1530. The predefined work schedule used for this comparison may be based on at least the work type and compensation rules, including overtime rules, associated with the time-entering user. Further, the set of compensation rules selected for the comparison may be determined from among multiple sets of rules based on, as a minimum, the location or cost center associated with the user. Based on the comparison, the timesheet page application 400 may calculate time adjustment data based on discrepancies (e.g., either higher or lower actual worked hours) between the actual hours worked as entered by the user and the scheduled hours to be worked for that user for the reporting period. The timesheet page application 400 may use the common calculation routines in calculating the time adjustment data. The timesheet page application 400 may organize the time entry data, the predefined work schedule, and the time adjustment data into a user time file suitable for upload to the web server 102, at 1535.

For an employee user selecting entry of a planned absence, the web server 102 may in response download the planned absence page 900 to the computing device 101. The user may then interact with the timesheet page application 400 to enter the planned absence request using the planned absence page 900 as described herein, at 1540. In at least one embodiment, an employee may delete a pending planned absence (e.g., prior to BTA approval) using the planned absence page 900.

In at least one embodiment, for an administrative user requesting access for timesheet or absence approval, the web server 102 may in response download either the timesheet approvals summary page 1200 or the planned absence approvals page 1000 to the computing device 101. The user may then interact with the timesheet page application 400 to enter the approval indications and comments using either pages 1000 or 1200 as described herein, at 1545. For an administrative user requesting access for timesheet, the administrative user may further request the timesheet approval detail page. The web server 102 may in response download the timesheet approval detail page to the computing device 101.

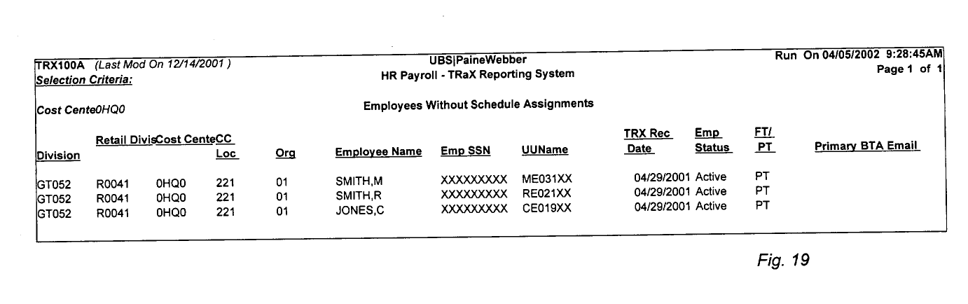

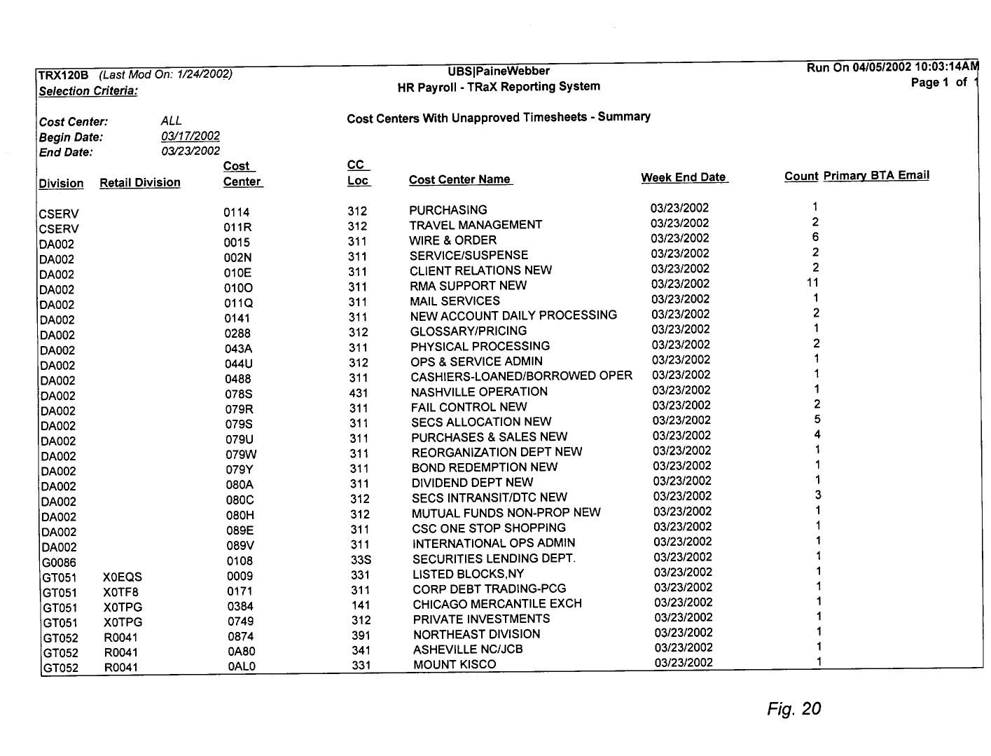

Alternatively, an administrative user, such as a BTA, may generate an approval report using the computing device 101. The approval report may list the approval status granted by the BTA for one or more submitted timesheets. The approval report may be subsequently provided to organization payroll operations or accounting operations via its personnel such as a GTA. The approval report may be transmitted by the computing device 101 to the web server 102 upon administrative user request, or it may be provided directly to payroll operations personnel in hardcopy form. In at least one embodiment, summary information may be available to all administrative levels via the previously discussed pages. A ‘hardcopy’ of these pages can be accomplished by, for example, activating the ‘page print’ functionality of the browser. In addition, GTAs may have access to Visual Basic® compatible Crystal® reports as a client-server application to generate a number of reports using the timesheet related information described herein. Such an application may operate upon the data contained in the TRAX 100 system timesheet database 108 and allow users to display or print certain summary and detail information. A Visual Basic® front end application may be used to allow report and report parameter selection by the GTA for report generation. An example of a report provided by at least one embodiment of the TRAX 100 system showing employees with missing timesheets is shown in FIG. 18. A further example of a report provided by at least one embodiment of the TRAX 100 system showing employees without schedule assignments is shown in FIG. 19. A still further example of a report provided by at least one embodiment of the TRAX 100 system showing cost centers with unapproved timesheets is shown in FIG. 20. Reports provided by the TRAX 100 system may include, for example:

Employees without schedule assignments (See example at FIG. 19)

Employees with incorrect schedule assignments—hours

Full-time employees with schedule recompensable hours equal to worked hours

Cost centers with employees missing timesheets

Cost centers with employees with unapproved timesheets (See example at FIG. 20)

Employees missing timesheets (See example at FIG. 18)

Employees with unapproved timesheets

Outstanding payment override records

New employees without EDB records

New employees with mismatched EDB records

Revised Financial Advisor FA charges

Terminated employees

Three-plus weeks of unapproved timesheets

Invalid schedules based on OVT states

In at least one embodiment, new employee setup may be accomplished using new employee setup page 600 (reference FIG. 6) to enter information into the TRAX system 100 for employees whose records are not yet on the mainframe employee database. Once established and assigned to a schedule, these employees will be able to start entering their time. The schedule setup page 700 (reference FIG. 7) may be used by a BTA to create new schedules or to update existing schedules.

For an administrative user requesting access to assign a schedule to an employee, the web server 102 may in response obtain the currently assigned schedule for the requesting employee user from the timesheet database 108 and download the employee schedule assignment page 800 to the computing device 101. The user may then interact with the timesheet page application 400 to assign a different schedule to an employee using page 800 as described herein, at 1555. For employee users who have no previous schedule assignment, the schedule information on page 800 may appear blank.

For an administrative user requesting access to adjust a timesheet, the web server 102 may in response obtain the associated timesheet 530 for the requesting employee user (for the requested workweek) from the timesheet database 108, and download the associated historical adjustment detail page 1400 to the computing device 101. The user may then interact with the timesheet page application 400 to enter the hourly adjustments to the timesheet using page 1400 as described herein, at 1557.

At the completion of data entry processing, an administrative user may choose to generate an alert message to a particular user or set of users, at 1560. The alert may be addressed to all users of the TRAX 100 system, to users at one or more particular locations or cost centers. The timesheet page application 400 may provide an interactive text box for the administrative user to create the content for the alert message, and then tag the alert message as an alert box message for the web server 102 to process accordingly. It should be understood that the TRAX 100 system may automatically generate alert messages upon the occurrence of one of a set of predefined alerting conditions. Further, alerts may be categorized into one of multiple priority levels, such as informational, warning, and critical levels. In at least one embodiment, a BTA 515, or employee user 535, may not enter information into the TRAX 100 system without first acknowledging any outstanding open alerts at or above a predefined alert level, such as a critical alert level.

Following entry of data and completion of the user interaction with timesheet page application 400 in 1527 through 1560, the timesheet page application 400 may upload the entered data, revised information, and/or alert messages to the web server 102 in accordance with the HTTP protocol, at 1565. Upon receiving the uploaded information, the web server 102 may cause the modified information to be stored in corresponding records and fields of the timesheet database 108 at 1570.

The TRAX 100 system may next extract or determine time adjustment data from the uploaded timesheet data at 1575. The time adjustment data may include all payment adjustments outside of the employee's obligation. For example, if an employee is obligated to work a 20 hour (e.g., part time) work week, then that employee may be assigned a 20 hour work week schedule by the TRAX 100 system. The employee may automatically be paid for 20 hours of work in a work week and the TRAX 100 system may not upload time adjustment data to the central processing system 104. However, if the employee works for 30 hours in a work week, then the TRAX 100 system may determine that the employee worked for 10 additional hours (e.g., “10:00 ADL” in FIG. 12) and the TRAX 100 system may upload time adjustment data to the central processing system 104 indicating that 10 additional hours were worked by the employee for that work week. If, for example, the employee works for 50 hours in a work week, then the TRAX 100 system may determine that the employee worked for 20 additional hours and 10 overtime hours, depending on the overtime rules in the jurisdiction in which the employee performed the work (e.g., “20:00 ADL” and “10:00 OVT” in FIG. 12) and the TRAX 100 system may upload time adjustment data to the central processing system 104 indicating that 20 additional hours and 10 overtime hours were worked by the employee for that work week. In at least one embodiment, the overtime rules may include state overtime compensation rules and organization business rules.

Scheduled batch processes executing on the database server 103 may convert the time adjustment data into a format suitable for processing by a central processing system 104, such as a flat file, at 1580. The converted time adjustment data may then be output to the central processing system 104 at 1585, such as a payroll system, for payroll compensation adjustments for the affected employee. Processing may end at 1595.

Alternatively, the time adjustment data may be extracted by an administrative user who, using an editing capability, copies the time adjustment data from the uploaded approved timesheet records to a separate file having the format required by the central processing system 104. The editing capability may be provided by the web server 102, or by an external system. The extracted and converted records may then be provided to the central processing system 104 for further processing (e.g., payroll processing) by transmitting the converted records from the web server 102 to the central processing system 104 using a communications link. Alternatively, the web server 102 may generate a converted records report which is subsequently provided to the central processing system 104 via communication link, or conveyed in hardcopy form to the central processing system 104 personnel for input. The non-automated aspects of conveying the time adjustment data to the central processing system 104 may be useful when, for example, there is no secure communication link between the web server 102 and the central processing system 104.

In addition, the TRAX 100 system may provide the capability for an administrative user to set a payment override indicator on a timesheet status summary page 1200. The payment override capability may be used, for example, to prevent a new employee from being paid twice after the new employee's mainframe payroll record has been established.

Furthermore, the TRAX 100 system may provide the capability for a BTA to establish one or more secondary BTAs to provide certain authorized BTA functions should the primary BTA be unavailable. A secondary BTA may have the same level of access to employee and cost center information as the primary BTA, or limited access. A secondary BTA may or may not be able to make timesheet approvals. The NTA may be provided the capability to establish primary BTAs, update employee records, define official holidays, define overtime rules, define work rules, and establish the timeclock requirement or a cost center.

Thus, a timesheet reporting and extraction method and system has been presented that provides, among other things, creation and modification of common work schedules, the assignment of schedules to individual employees, the entry and approval of planned absences, the entry and approval of weekly timesheets, the historical correction of employee timesheets, and the automated or semi-automated uploading and reporting of employee time to the mainframe for payroll processing. Furthermore, each employee's regular, additional, overtime, doubletime, and negative hours may be determined using common organization approved calculation routines.

While the embodiments of the invention has been described above, it is evident that many alternatives, modifications and variations will be apparent to those skilled in the art. Accordingly, the embodiments of the invention, as set forth above, are intended to be illustrative, and should not be construed as limitations on the scope of the invention. Various changes may be made without departing from the spirit and scope of the invention. Accordingly, the scope of the present invention should be determined not by the embodiments illustrated above, but by the claims appended hereto and their legal equivalents.

What is claimed is:

1. An automated time entry method comprising:
accepting, via a first computing device, user-provided time entry data from a first user entered via a data entry device;
comparing the time entry data to a predefined work schedule for the first user, the predefined work schedule being based on at least a work type and a set of compensation rules, the set of compensation rules being selected from a plurality of sets based on at least a location with which the first user is associated;
generating time adjustment data that identifies discrepancies between the time entry data and the predefined work schedule;
organizing the time entry data, the predefined work schedule, and the time adjustment data into a user time file; and
outputting the user time file from the first computing device to a server via a network.

2. The method of claim 1, wherein the time entry data includes data indicating total time worked by the first user in a work period.

3. The method of claim 1, wherein accepting time entry data further comprises:
accepting one or more start times and end times from the user, the time entry data including at least one pair of a start time and an end time; and
calculating a total time worked based upon the at least one start time and end time, the time entry data further including the calculated total time worked.

4. The method of claim 1, further comprising:
accepting an approval indicator using a second computing device, the approval indicator being operative to establish local administrative approval of the time entry data;
outputting the approval indicator from the second computing device to the server; and
receiving and reporting one or more alert messages to at least one local administrator using the second computing device.

5. The method of claim 4, further comprising:
allowing different levels of access to the user time file according to a plurality of predefined access levels, said access levels including a user level, a local administrator level, and a general administrator level, the accepting of the approval indicator occurring only upon receipt of the approval indicator from a second user associated with the local administrator level or the organization administrator level; and
preventing the first user associated with the user level from modifying the time entry data after the approval indicator is set.

6. The method of claim 1 wherein the set of compensation rules further includes a set of overtime rules.

7. The method of claim 1, wherein the outputting is performed upon user request.

8. The method of claim 1, wherein the location is further associated with at least one cost center.

9. The method of claim 1, wherein the location is further associated with a governmental jurisdiction.

10. The method of claim 1, the method further comprising outputting the time adjustment data to a central processing system.

11. The method of claim 10, the method further comprising converting time adjustment data from a workweek time basis to a payment type basis.

12. The method of claim 1, further comprising:
representing the user time file as an electronic timesheet;
maintaining each of a plurality of user time files to form a chronological timesheet history; and
adjusting the timesheet history in response to employee or administrator requests.

13. The method of claim 1, the method further comprising receiving employee information from the server using the network.

14. A time entry system, comprising:
a first server including a transaction creation module, and an interface to a central processing system;
a second server including a timesheet page application configured to execute on each of the computing devices and including an output portion operable to output pages to a human-machine interface included in each of a first and second computing devices, the second server being coupled to at least first and second computing devices via a network and being coupled to the first server, the timesheet page application being further configured to:
output a timesheet page to the at least one human-machine interface,
accept time entry data from a first user via a data entry device of the first computing device,
compare the time entry data to a predefined work schedule associated with the first user, said predefined work schedule being based on at least a work type and a set of compensation rules, said set of compensation rules being selected from among a plurality of sets based upon at least a location with which the first user is associated,
generate time adjustment data identifying any discrepancies between the time entry data and said predefined work schedule,
collect the time entry data, said predefined work schedule, and said time adjustment data into a user time file, and
output the user time file from said first computing device to the second server using the network.

15. The system of claim 14, wherein the second server is configured to download the timesheet page application to the first and second computing devices using the network.

16. The system of claim 14, the system further comprising:
an employee timesheet database; and
wherein the second server comprises a web server and the first server comprises a database server, the database server being coupled to the web server and to the employee timesheet database, and the database server being configured to store and retrieve timesheet information to and from the employee timesheet database.

17. The system of claim 14, wherein the time entry data comprises total time worked by the first user in a work period.

18. The system of claim 14, wherein the first computing device is further configured to:
accept only one or more start times and end times from the first user, wherein the time entry data comprises at least one pair of a start time and an end time; and
calculate a total time worked based upon the start times and end times, wherein the time entry data further comprises the calculated total time worked.

19. The system of claim 14, wherein the second computing device is configured to:
accept an approval indicator entered by a second user, the second user being an administrative user, the approval indicator operative to establish local administrative approval of the time entry data;
output the approval indicator to the second server; and
receive and report one or more alert messages.

20. The system of claim 14, wherein the second server further comprises:
an access manager module, the access manager module being configured to allow different levels of access to the user time file according to a plurality of predefined access levels, the access levels including a user level, a local administrator level, and a general administrator level, the access manager being further configured to prevent a first user associated with the user level from modifying the time entry data after the approval indicator is set; and
the second computing device being further configured to accept entry of the approval indicator only from a second user being associated with the administrator level or the general administrator level.

21. The system of claim 14 wherein the compensation rules further comprise a set of overtime rules.

22. The system of claim 14, wherein the first computing device is further configured to output the user time file upon user request.

23. The system of claim 14, wherein the location is further associated with at least one cost center.

24. The system of claim 14, wherein the location is further associated with a governmental jurisdiction.

25. The system of claim 14, wherein the first server is further configured to output the time adjustment data to a central processing system.

26. The system of claim 25, wherein the second server is further configured to convert the time adjustment data from a workweek time basis to a payment type basis.

27. The system of claim 14, wherein the timesheet page application is further configured to:
represent the user time file as an electronic timesheet;
maintain each of a plurality of the user time files to form a chronological timesheet history; and
adjust the timesheet history in response to employee or administrator requests.

28. The system of claim 14, wherein the first and second computing devices are further configured to receive employee information from the second server using the network.

29. A time entry system, comprising:
means for computing, said computing means including a data entry device;
means for serving, the serving means coupled to the computing means via a network, the serving means being configured to receive commands and data from the computing means and to output program code and data to the computing means using the network; and
data storage means coupled to the serving means, the data storage means including employee information;
wherein the computing means is configured to
accept time entry data from a first user via a data entry device,
compare the time entry data to a predefined work schedule for the first user, the predefined work schedule being based on at least a work type and a set of compensation rules, the set of compensation rules being selected from among a plurality of sets based upon at least a location with which the first user is associated,
generate time adjustment data identifying any discrepancies between the time entry data and the predefined work schedule,
collect the time entry data, the predefined work schedule, and the time adjustment data into a user time file, and
output the user time file to the serving means using the network.

30. The system of claim 29, wherein the time entry data comprises total time worked by the first user in a work period.

31. The system of claim 29, wherein the computing means is further configured to:
accept only one or more start times and end times from the first user, wherein the time entry data comprises at least one pair of a start time and an end time; and
calculate a total time worked based upon the start times and end times, wherein the time entry data further comprises the calculated total time worked.

32. The system of claim 29, wherein the computing means is further configured to:
accept an approval indicator entered by a second user, the second user being an administrative user, the approval indicator operative to establish local administrative approval of the time entry data;
output the approval indicator to the serving means; and
receive and report one or more alert messages.

33. The system of claim 32, wherein the computing means is further configured to:
allow different levels of access to the user time file according to a plurality of predefined access levels, the access levels including a user level, a local administrator level, and a general administrator level;
accept entry of the approval indicator only from the second user if the second user is associated with the local administrator level or the general administrator level; and
prevent the first user, associated with the user level, from modifying the time entry data after the approval indicator is set.

34. The system of claim 29 wherein the compensation rules further comprise a set of overtime rules.

35. The system of claim 29, wherein the computing means is further configured to output the user time file upon user request.

36. The system of claim 29, wherein the location is further associated with at least one cost center.

37. The system of claim 29, wherein the location is further associated with a governmental jurisdiction.

38. The system of claim 29, wherein the serving means is further configured to output the time adjustment data to a central processing system.

39. The system of claim 38, wherein the serving means is further configured to convert the time adjustment data from a workweek time basis to a payment type basis.

40. The system of claim 29, wherein the computing means is further configured to: represent the user time file as an electronic timesheet;
maintain each of a plurality of user time files to form a chronological timesheet history; and
adjust the timesheet history in response to employee or administrator requests.

41. The system of claim 29, wherein the computing means is further configured to receive employee information from the serving means using the network.

42. A computer-readable medium upon which is embodied a set of programmable instructions that when executed cause a processor to:
accept time entry data from a first user via a data entry device;
compare the time entry data to a predefined work schedule for the first user, the predefined work schedule being based on at least a work type and a set of compensation rules, the set of compensation rules selected from among a plurality of sets based upon at least a location with which the first user is associated;
generate time adjustment data identifying any discrepancies between the time entry data and the predefined work schedule;
collect the time entry data, the predefined work schedule, and the time adjustment data into a user time file; and
output the user time file.

43. The computer-readable medium of claim 42, wherein the time entry data comprises total time worked by the first user in a work period.

44. The computer-readable medium of claim 42, wherein the programmable instructions further cause an executing processor to:
accept only one or more start times and end times from the first user, wherein the time entry data comprises at least one pair of a start time and an end time; and
calculate a total time worked based upon the start times and end times, wherein the time entry data further comprises the calculated total time worked.

45. The computer-readable medium of claim 42, wherein the programmable instructions further cause an executing processor to:
accept an approval indicator entered by an administrative user, the approval indicator being operative to establish local administrative approval of the time entry data;
output the approval indicator; and
receive and report one or more alert messages.

46. The computer-readable medium of claim 45, wherein the programmable instructions further cause an executing processor to:
allow different levels of access to the user time file according to a plurality of predefined access levels, the access levels including a user level, a local administrator level, and a general administrator level;
accept entry of the approval indicator only from a second user associated with the local administrator level or the general administrator level; and
prevent a first user associated with the user level from modifying the time entry data after the approval indicator is set.

47. The computer-readable medium of claim 42 wherein the compensation rules further comprise a set of overtime rules.

48. The computer-readable medium of claim 42, wherein the programmable instructions further cause an executing processor to output the user time file upon user request.

49. The computer-readable medium of claim 42, wherein the location is further associated with at least one cost center.

50. The computer-readable medium of claim 42, wherein the location is further associated with a governmental jurisdiction.

51. The computer-readable medium of claim 42, wherein the programmable instructions further cause an executing processor to output the time adjustment data to a central processing system.

52. The computer-readable medium of claim 51, wherein the programmable instructions further cause an executing processor to convert the time adjustment data from a workweek time basis to a payment type basis.

53. The computer-readable medium of claim 42, wherein the programmable instructions further cause an executing processor to:
represent the user time file as an electronic timesheet;
maintain each of a plurality of the user time files to form a chronological timesheet history; and
adjust the timesheet history in response to employee or administrator requests.

54. The computer-readable medium of claim 42, wherein the programmable instructions further cause an executing processor to receive employee information using a network.
